(19) United States
(12) Patent Application Publication
(10) Pub. No.: US 2026/0044776 A1
(43) Pub. Date: Feb. 12, 2026

(54) Reward or Preference Optimization of Sequence Processing Models with Asymmetric Matching Losses

(71) Applicant: DeepMind Technologies Limited, London (GB)

(72) Inventors: Gil Shamir, Sewickley, PA (US); Manfred Klaus Warmuth, Santa Cruz, CA (US)

(21) Appl. No.: 18/800,677

(22) Filed: Aug. 12, 2024

(51) Int. Cl. G06N 20/00

(52) U.S. Cl. CPC G06N 20/00

(57) ABSTRACT

Provided are systems and methods for fine-tuning sequence processing models (e.g., Large Language Models (LLMs) or Large Multimodal Models (LMMs)) to human preferences. Specifically, provided are systems and methods for application of matching losses, including asymmetric matching losses, at various stages of aligning sequence processing models to reward or preference labels that capture human preferences.

### FIELD

The present disclosure relates generally to machine learning processes and machine-learned devices and systems. More particularly, the present disclosure relates to reward or preference optimization of sequence processing models with asymmetric matching losses.

### BACKGROUND

A computing system can receive input(s). The computing system can execute instructions to process the input(s) to generate output(s) using a parameterized model. For example, the input can be a query or a prompt and the output can be a response to the query or the prompt. The computing system can obtain feedback on its performance in generating the outputs with the model. For example, the computing system can generate feedback by evaluating its own performance and/or the computing system can receive feedback from an external source. The computing system can update parameters of the model based on the feedback to improve its performance. In this manner, the computing system can iteratively “learn” to generate the desired outputs. The resulting model is often referred to as a machine-learned model.

Neural networks are a specific type of machine learning model that employ one or more layers of nonlinear units to predict an output for a received input. Some neural networks include one or more hidden layers in addition to an output layer. The output of each hidden layer is used as input to the next layer in the network, e.g., the next hidden layer or the output layer. Each layer of the network generates an output from a received input in accordance with current values of a respective set of parameters.

### SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

One example aspect includes a computing system for reward or preference optimization of sequence processing models. The computing system includes one or more processors. The system also includes one or more non-transitory computer-readable media that collectively store instructions that, when executed by the one or more processors, cause the computing system to perform operations. The operations include obtaining, by the computing system, a training example may include one or more sequences of tokens and one or more reward or preference labels respectively associated with the one or more sequences of tokens. The operations include evaluating, by the computing system, an optimization function based on: (i) a reference score generated by a reference sequence processing model for the one or more sequences of tokens and (ii) a target score generated by a target sequence processing model for the one or more sequences of tokens. The operations include where the optimization function may include a reward or preference function that is fit to the one or more reward or preference labels using a training loss function. The operations include where the reward or preference function provides a predicted reward or preference score expressed in terms of both the reference score and the target score. The operations include where the training loss function may include a matching loss function that evaluates an area under a monotonically-non-decreasing link function from a label value of the one or more reward or preference labels to the predicted reward or preference score. The operations include modifying, by the computing system, one or more values of one or more parameters of the target sequence processing model based on the optimization loss function. Other embodiments of this aspect include corresponding computer systems, apparatus, and computer programs recorded on one or more computer storage devices, each configured to perform the actions of the methods.

Implementations may include any combination of one or more of the following features. The computing system where: the one or more sequences of tokens may include a single-trajectory sequence of tokens; the one or more reward or preference labels may include a pointwise reward label for the single sequence of tokens; the reward or preference score may include a reward score expressed in terms of the reference score and the target score; and the matching loss function is applied to fit the pointwise reward label of the single-trajectory sequence of tokens to the reward score. The optimization function is directly defined with the link function through its gradient relative to the target score but not the reward function. The one or more sequences of tokens may include a pair of sequences of tokens; the one or more reward or preference labels may include a preference label for the pair of sequences of tokens; the reward or preference score may include a preference score expressed in terms of the reference scores and the target scores for the pair of sequences of tokens; and the matching loss function may be applied to fit the preference label of the pair of sequences of tokens to the preference score. The link function may include a hyperbolic sine function, a hyperbolic arctangent function, an arcsin function, or an asymmetric function convex on a first quadrant that has been scaled. The link function may include an asymmetric function. The link function may include an exponential function. The link function may include a linear function, a standard sigmoid function, or a sigmoid function that has been one or both of scaled and shifted. The optimization function may be analytically inexpressible but a gradient of the training loss function may include a difference in evaluations of the link function at the predicted reward or preference score and the label value, and where evaluating, by the computing system, the optimization function may include determining, by the computing system, a gradient of the optimization function. The predicted reward or preference score and the label value may include logit scores. The predicted reward or preference score and the label value may include probabilities. The one or more reward or preference labels may include fractional labels that designate a fractional level of reward or preference. The optimization function further may include or is derived from a regularization term that penalizes a divergence between the reference score and the target score. The regularization term may include a second matching loss function that evaluates a second area under a second montonically-non-decreasing link function from the target score to the reference score. Implementations of the described techniques may include hardware, a method or process, or computer software on a computer-accessible medium.

One example aspect includes a computer-implemented method for reward or preference optimization of sequence processing models. The computer-implemented method also includes obtaining, by a computing system may include one or more computing devices, a reward or preference training example may include one or more sequences of tokens and one or more reward or preference labels respectively associated with the one or more sequences of tokens. The method also includes evaluating, by the computing system, an optimization function based on: (i) a reference score generated by a reference sequence processing model for the one or more sequences of tokens and (ii) a target score generated by a target sequence processing model for the one or more sequences of tokens. The method also includes where the optimization function may include or is derived from a regularization term that penalizes divergence between the reference score and the target score. The method also includes where the regularization term may include a matching loss function that evaluates an area under a monotonically-non-decreasing link function from the reference score to the target score. The method also includes modifying, by the computing system, one or more values of one or more parameters of the target sequence processing model based on the optimization loss function. Other embodiments of this aspect include corresponding computer systems, apparatus, and computer programs recorded on one or more computer storage devices, each configured to perform the actions of the methods.

Implementations may include any combination of one or more of the following features. The computer-implemented method where the link function may include an asymmetric function The link function may include an exponential function. The link function may include a linear function, a standard sigmoid function, or a sigmoid function that has been one or both of scaled and shifted. The link function may include a hyperbolic sine function, a hyperbolic arctangent function, an arcsin function, or an asymmetric function convex on the first quadrant that has been scaled. The link function is applied directly to a sequence pairwise difference of the target and reference scores. Implementations of the described techniques may include hardware, a method or process, or computer software on a computer-accessible medium.

One example aspect includes a computer-implemented method for performing reward or preference optimization. The computer-implemented method also includes obtaining, by a computing system may include one or more computing devices, a plurality of training examples each may include one or more sequences of tokens and one or more reward or preference labels respectively associated with the one or more sequences of tokens. The method also includes training, by the computing system, a reward or preference model on the plurality of training examples, where training the reward or preference model may include training the reward or preference model to generate a reward or preference score for a given sequence. The method also includes where, for at least one of the training examples, training the reward or preference model may include evaluating a matching loss function that evaluates an area under a monotonically-non-decreasing link function from a label value of the one or more reward or preference labels included in the training example to the reward or preference score generated by the reward or preference model. The method also includes performing, by the computing system, optimization of a target sequence processing model with respect to the reward or preference model, where the optimization is performed using training example sequences generated by the target sequence processing model. The method also includes where, for at least one of the training example sequences generated by the target sequence processing model, performing optimization of the target sequence processing model may include evaluating a gradient of a matching loss function that evaluates the derivative of an area under a monotonically-non-decreasing link function from a reward or preference label or an expected label value of another sequence or sequences to the reward or preference score generated by the reward or preference model. Other embodiments of this aspect include corresponding computer systems, apparatus, and computer programs recorded on one or more computer storage devices, each configured to perform the actions of the methods.

One general aspect includes a computer-implemented method for performing reward or preference optimization. The computer-implemented method also includes obtaining, by a computing system may include one or more computing devices, a plurality of training examples each may include one or more sequences of tokens and one or more reward or preference labels respectively associated with the one or more sequences of tokens. The method also includes training, by the computing system, a reward or preference model on the plurality of training examples, where training the reward or preference model may include training the reward or preference model to generate a reward or preference score for a given sequence. The method also includes performing, by the computing system, optimization of a target sequence processing model with respect to the reward or preference model, where the optimization is performed using training example sequences generated by the target sequence processing model. The method also includes where performing the optimization of the target sequence processing model may include evaluating a regularization term that may include a matching loss function that evaluates an area under a monotonically-non-decreasing link function from a reference score generated by a reference sequence processing model to the target score generated by the target sequence processing model. Other embodiments of this aspect include corresponding computer systems, apparatus, and computer programs recorded on one or more computer storage devices, each configured to perform the actions of the methods.

### BRIEF DESCRIPTION OF THE DRAWINGS

FIG. 1 is a block diagram of an example approach for training sequence processing models according to example implementations of aspects of the present disclosure;

FIG. 2 illustrates a graph diagram of matching loss as an area under an example link function according to example implementations of aspects of the present disclosure;

FIG. 3 illustrates graph diagrams demonstrating loss regions for example matching losses according to example implementations of aspects of the present disclosure;

FIGS. 4A and 4B illustrate graph diagrams demonstrating example link functions according to example implementations of aspects of the present disclosure;

FIGS. 5A and 5B illustrate graph diagrams of predicted expected label with an exponential link matching loss according to example implementations of aspects of the present disclosure;

FIG. 6 is a flow chart diagram illustrating an example method for finetuning a sequence processing model according to example implementations of aspects of the present disclosure;

FIG. 7 is a flow chart diagram illustrating an example method for finetuning a sequence processing model according to example implementations of aspects of the present disclosure;

FIG. 8 is a flow chart diagram illustrating an example method for training a machine-learned model according to example implementations of aspects of the present disclosure;

FIG. 9 is a block diagram of an example processing flow for using machine-learned model(s) to process input(s) to generate output(s) according to example implementations of aspects of the present disclosure;

FIG. 10 is a block diagram of an example sequence processing model according to example implementations of aspects of the present disclosure;

FIG. 11 is a block diagram of an example technique for populating an example input sequence for processing by a sequence processing model according to example implementations of aspects of the present disclosure;

FIG. 12 is a block diagram of an example model development platform according to example implementations of aspects of the present disclosure;

FIG. 13 is a block diagram of an example training workflow for training a machine-learned model according to example implementations of aspects of the present disclosure;

FIG. 14 is a block diagram of an inference system for operating one or more machine-learned model(s) to perform inference according to example implementations of aspects of the present disclosure;

FIG. 15 is a block diagram of an example networked computing system according to example implementations of aspects of the present disclosure;

FIG. 16 is a block diagram of an example computing device according to example implementations of aspects of the present disclosure; and

FIG. 17 is a block diagram of an example computing device according to example implementations of aspects of the present disclosure.

### DETAILED DESCRIPTION

### Overview

Example aspects of the present disclosure are directed to systems and methods for fine-tuning sequence processing models (e.g., Large Language Models (LLMs) or Large Multimodal Models (LMMs)) to human preferences. Specifically, the present disclosure proposes the application of matching losses, including asymmetric matching losses, at various stages of aligning sequence processing models to reward or preference labels that capture human preferences.

Alignment, whether implemented through methods like Reinforcement Learning with Human Feedback (RLHF), Direct Preference Optimization (DPO), Identity Preference Optimization (IPO), or other general methodologies, typically involves selecting a reward function based on human-labeled scores, choosing a regularizer to maintain proximity between the target and reference models, and deciding on a training loss to effectively fit the human-labeled scores.

According to an aspect of the present disclosure, matching losses can be effectively utilized for the latter two components. Specifically, matching losses, such as asymmetric matching losses, can be employed to fit reward or preference labels, thereby enhancing stronger preferences over weaker ones in the target model.

The proposed matching losses can be used to fit either reward labels associated with single-trajectory sequences of tokens or preference labels associated with two or more sequences of tokens. Specifically, a ‘reward label’ can refer to an individual score assigned to a single sequence or response to a prompt, reflecting a completion or answer consisting of a series of tokens. In contrast, a ‘preference label’ can denote a contrastive label, indicating the level at which one sequence is favored over another. Example implementations of the present disclosure can apply matching loss techniques to both single-trajectory cases, where monotonically increasing link functions like Sigmoid and exponent are utilized, and contrastive cases, where asymmetric functions like sinh are employed to robustly handle the directionality in sequence pairs.

Additionally or alternatively, matching losses provide a straightforward and flexible means to regularize the target distribution towards a reference distribution, allowing the regularization to concentrate more effectively on matching significant probabilities or probability differences, while minimizing the emphasis on differences between the reference and target for sequences with low probabilities.

More particularly, current approaches in the field of sequence processing models typically involve standard training loss functions such as cross-entropy or mean squared error, which do not differentiate between the types of errors made by the model. These conventional methods treat all discrepancies between the model's output and the target data uniformly, regardless of the significance or impact of the error on the overall system performance. This approach can lead to inefficiencies in model training, as it does not prioritize learning from the most impactful errors, potentially resulting in longer training times and increased computational resource usage. Additionally, these methods often lack flexibility in regularization, which can prevent the model from adequately adapting to new data while staying true to a reference model, thereby hindering the model's ability to generalize well across different datasets.

In view of these challenges, the present disclosure proposes the use of matching losses, including asymmetric variants, in the alignment of sequence processing models to reward or preference labels that capture human preferences. The alignment process can be implemented through various methods such as RLHF, DPO, IPO, or other frameworks. In particular, each of these frameworks can include the steps of selecting a reward function based on reward or preference labels, choosing a regularizer, and deciding on a training loss that fits the reward function to the labels.

According to one aspect of the present disclosure, matching losses can be used as the training loss that fits the reward function to the labels. Specifically, matching losses, particularly asymmetric ones, are effective in fitting labels as they prioritize more definite human preferences over ambiguous ones in the target model. This ensures that the model aligns more closely with clear human preferences, enhancing the accuracy of the model in reflecting human intentions.

According to another aspect of the present disclosure, matching losses can also be used in the regularization process of aligning the target distribution towards a reference distribution. Specifically, they simplify and enhance the flexibility of this process by allowing the regularization to focus more effectively on matching larger probabilities or significant probability differences. This minimizes the emphasis on discrepancies between the reference and target models for sequences with low probabilities, thereby potentially improving the overall efficiency of the alignment process in cases where more definite rewards or preference differences indicate more reliable human preferences.

Thus, matching losses can be used to optimize the alignment of sequence processing models to human preferences. Matching losses can be particularly advantageous in scenarios where differentiation between certain types of responses is desired over others. For instance, matching losses can prioritize responses that are more aligned with strongly expressed human preferences, thereby enhancing the model's overall performance in generating highly preferred sequences.

In some implementations, matching losses can be implemented through the use of various link functions. These link functions can include, but are not limited to, linear functions, exponential functions, sigmoid functions, hyperbolic sine functions, hyperbolic arctangent functions, arcsin functions, and other monotonically increasing functions or monotonically-non-decreasing functions. Each type of link function can offer different characteristics in terms of how losses are calculated and applied. For example, an exponential link function can increase sensitivity to differences in higher value regions, effectively focusing the model's learning on more significant discrepancies.

Example implementations of the present disclosure can also utilize asymmetric matching losses, which are particularly useful for emphasizing or discounting specific aspects of the model's predictions. Asymmetric matching losses can be designed to focus more on significant differences in label values, thereby guiding the sequence processing model to pay more attention to more impactful discrepancies.

In some implementations, example optimization functions generated from the matching losses may be analytically inexpressible. However, the gradient of such optimization functions may be computable. For example, the gradient may equal a difference in evaluations of the link function at a predicted reward or preference score and a label value. Thus, the proposed techniques can be applied to perform gradient-based optimization techniques, even when an optimization function generated from the matching loss is not itself analytically expressible.

As mentioned, example implementations of the present disclosure can fit models to both pointwise reward labels and/or pairwise preference labels. This can be beneficial in scenarios where different combinations of label types are available for training. By using matching losses, the technology can effectively handle different types of training data and optimize the model accordingly.

The disclosed technology provides a significant technical effect by optimizing the alignment of sequence processing models to human preferences using matching losses, which enhances the model's ability to generate sequences that satisfy various preferences for various different use cases. This optimization can be achieved through the implementation of specific link functions within the matching losses, such as exponential, linear, sigmoid, hyperbolic sine, hyperbolic arctangent, and arcsin functions. These functions allow for a nuanced adjustment of the model's responses based on varying degrees of human preferences, thereby improving the relevance and accuracy of the model's output. Not only can this optimization improve the accuracy of the sequence processing model on more important sequences, but it can also reduce the computational resources required, as the model becomes more adept at generating preferred responses without unnecessary iterations (e.g., requests for revised outputs/completions). This is attained by effectively ignoring examples that give less important information of distinguishing between sequences that do not matter (with low reward scores).

Furthermore, the proposed technology enhances technical performance by implementing asymmetric matching losses that focus on significant discrepancies in model predictions. This approach allows the model to prioritize learning from more impactful errors, which is a technical advancement over traditional models that may treat all errors with equal importance. By focusing on these significant discrepancies, the technology ensures that the sequence processing models are not only more aligned with human preferences but also are trained with enhanced efficiency and effectiveness in cases where significant differences are more likely to represent reality, and small preferences or reward scores are more likely to be unreliable (or noise). Because human labels are indeed noisy such assumptions are very realistic. Thus, this targeted learning approach reduces the time and computational power needed to train the models, thereby providing a technical benefit in terms of resource management and consumption. In particular, faster training of the models can result in less consumption of computational resources such as processor cycles, memory usage, etc.

In addition, the proposed technology addresses technical challenges associated with model regularization by utilizing matching losses in a novel way. Regularization ensures that the model's outputs do not deviate excessively from a reference model, which is important for maintaining the reliability of the predictions. The application of matching losses in regularization ensures that the model remains closely aligned with the reference for high reference probabilities while still accommodating necessary adaptations to meet human preferences.

Further, while example descriptions contained herein focus on application of the proposed techniques in a DPO-like offline learning approach, the proposed techniques can also be applied in an iterative, online RLHF optimization process. For example, in the RLHF setting, matching losses can be used to fit the reward or preference model to the reward or preference labels and/or can be used in the regularization of the target model when maximizing a reward from the reward or preference model. Then, in the reinforcement maximization step, matching losses can optionally be re-applied to adapt target probabilities to increase more substantially for high reward and/or preference sequences.

Specifically, the application in the RLHF setting involves first training a reward or preference model on a plurality of training examples. Each example includes sequence(s) of tokens paired with corresponding reward or preference label(s). The reward or preference model is trained to generate a predicted reward or each preference for each training example, which is a prediction of the reward or preference label associated with that training example. In some implementations, matching losses can be used during this portion of the process to fit the reward or preference model to the reward or preference labels.

Once the reward or preference model is established, iterative online optimization can be performed on a target sequence processing model to maximize a reward generated by the reward or preference model. In some implementations, at this stage of training, matching losses can be used in regularizing the target model towards a reference model. This regularization ensures that while the target model is optimized to align with human preferences, it does not diverge excessively from the baseline behaviors encoded in the reference model. Thus, the proposed techniques which leverage matching losses can be used in either an iterative online approach (e.g., like RLHF) or an offline optimization (e.g., like DPO/IPO).

In some implementations, matching losses can be also applied in the reward maximization step of RLHF, to apply larger gradients for sequences to which the learned reward model gives large reward.

### INTRODUCTION

### Introduction to Alignment of Large Language Models

Alignment of pre-trained sequence processing models is an increasingly important problem in generative AI systems. A large sequence processing model can be pre-trained on a massive training corpus, and then specialized or fine-tuned to different target uses. In many such applications there are no fine-tuning datasets to target the model. Instead, techniques like RLHF are used. The original pre-trained sequence processing model serves as a reference model. It generates initial sequences that are shown to human raters or to some existing preference models. The rater(s) annotate preference labels to these sequences. Those preferences are used to train a reward model. Then, the sequence processing model is fine-tuned (e.g., iteratively) to maximize a reward function which is a function of the preferences learned, with regularization towards the reference model, to ensure that the target model does not diverge too much from the reference. Too much divergence can lead to models that are unable to respond reasonably to prompts. In many cases, existing datasets with preference labels are used instead of human labeled data.

A recent line of work proposes to streamline techniques like RLHF into a single (supervised) preference optimization task applied on the language model. The general approach, initiated by the DPO paper, models the relation of three factors; the reference distribution, a reward function (of the reward or preference labels), and the target distribution, for the optimal solution of a constrained reward maximization problem. The problem maximizes some reward function subject to a constraint on some distance measure between the reference and target distributions. The reward function is then expressed in terms of both the reference and the target distributions, and a preference model fits the reward function to the reward or preference labels. Through expressing the reward function as a function of the unknown target distribution, fitting the preference predictions to the reward or preference labels leads to learning the target distribution.

Subsequent work to the DPO paper generalized the approach to include more general reward functions, for example including an identity function of the predicted preference probability as in IPO. Later work clustered DPO, IPO and SliC-HF, all as special implementations of a general framework with different reward and/or loss functions that fit the reward or preference labels. Additional work generalized DPO, replacing a KL-regularizer used for the distance measure between the reference and the target with a generalized f-divergence measure. Combining all these, one can consider a general framework where all the optimization components—the reward function, the regularizer, and the loss applied to fit the preference model to the reward or preference labels—can be selected from families of functions and loss functions.

The classical RLHF and alignment methods use pairwise preference labels. Raters are shown two different responses of a model to the same prompt, and are asked to rank between these responses. The preferences between the two models are then used to learn reward scores (e.g., either preference probabilities, logits, or other functions) for the two sequences. Learning these scores implicitly fine-tunes the learned target sequence processing model distributions. Because the labels describe a ranking between the two sequences in the pair, the losses used to train the preference model are in many cases pairwise learning-to-rank losses that are applied to a pair of learned scores (e.g., a score for each sequence).

In some applications, raters provide finer-grained differential grades between sequences. Instead of indicating that sequence λ isbetter than B, they can use a scale of several grades and give a grade difference that indicates by how much λ isbetter than B. In addition, some applications give, for each pair, an average preference score of multiple raters. This additional information may not be fully utilized by the training fine-tuning loss used for the preference model. While techniques like RLHF, DPO, IPO and others can use a fractional label that A is better 70% of the time and B is better 30%, it may not necessarily represent a realistic preference model. For example, if one rater prefers sequence A over B with a score of 0.7 (between 0 and 1), while seven other raters prefer B with a score of 0.1, it is possible that A should be overall preferred over B, because the preferences of B are rather uncertain, and should possibly be ignored, or at least discounted. This example suggests that introducing some bias towards more certain or strongly expressed preferences can sometimes be a more realistic view, which is not necessarily addressed by current methods. This can also apply to fine-tuning systems that use pointwise scores that tend to either fit the learned score to the average grade labels annotated by raters or to match scores to expected rater rewards, often not discounting low confidence grades relative to high confidence ones.

On the regularization side, regularizers, such as the (reverse) KL-divergence or the more general f-divergence, rely on the likelihood ratio between the target and the reference probabilities. This can force the targets to enforce that low reference probability sequences are also given (close) low target probabilities, even if the desire is to break away from the reference if the preference model suggests that. Similarly, direct divergences (or cross entropy) can heavily penalize possible lowering of high reference probabilities. As described in this work, regularizers based on matching losses can be designed to address such shortcomings.

### Introduction to Matching Losses and Bregman Divergence

Classical training losses, such as cross-entropy logistic regression, do not provide sufficient flexibility to match a target preferring some (arbitrary) label prediction values over others. Linear regression square losses are sensitive to outliers, and do not give preference to one region over another in the learned score (activation) domain.

Matching losses provide such flexibility. Consider a monotonically increasing link function h(z). The function can be, for example, linear, the standard logistic (Sigmoid) function, a scaled and/or shifted Sigmoid, or a standard or scaled and/or shifted exponential function. If we try to match a score \hat{α} to some ground truth label a, we can define the integral from α to \hat{α} on h(z)−h(α) as the loss. Such a loss is minimized (for a monotonically increasing h(z)) at \hat{α}=a. It has a gradient which equals h(\hat{α})−h(α) at z=\hat{α}, which is uniquely defined by the link function. Interestingly, this loss is a Bregman Divergence between points \hat{α} and a for the primitive antiderivative H(z) of the link function h(z). The standard binary cross-entropy loss is a special case with h(z)=σ(z)=1/(1+e^{-z}) where \hat{α} is the learned logit score, α=−∞ if the observed label is negative, and α=∞ with a positive observed label. A standard square loss is obtained with h(z)=z.

One benefit of using a matching loss is that its sensitivity can be defined for different regions of the values of both α and \hat{α}. For example, if an exponential link function such as h(z)=e^{z} is used (e.g., for a bounded domain of z to avoid exponentially large losses), the loss is more sensitive at large values of z. Differences for small and negative values of z are much smaller. Differences between a and \hat{α} when one is large and the other is small are also large.

This yields a loss that is focused on differentiating between large values of the label, and between large and small values, but generally discounting differences between small values of the labels. Such a behavior is further exhibited with asymmetric matching losses, which can be designed to focus on distinguishing between label values that are important to distinguish between, and discounting the differences where label values are less important, yet, not allowing less important label values to be predicted at levels of important labels.

Specifically, for human preferences, if the model learned a large preference difference between two sequences, and it sees another example pair with a small preference difference, such a loss can discount the differences of the new example pair, as they are likely the result of a rater who was uncertain about which of the two sequences is better, and they do not provide much added value to the optimization. Discounting examples that matter less gives the model the ability to focus its parameters on distinguishing between values where it matters more to make such distinctions.

### Introduction to Alignment and Matching Losses

The benefits of matching losses can be exploited for both(i) fitting reward or preference labels, whether they are pairwise preference labels or pointwise (single trajectory) reward labels, and/or for (ii) regularizing learned target distributions towards the reference pretrained distributions.

In fitting reward or preference labels, the loss can be designed to focus, unlike standard cross-entropy and Lₚ losses, on more certain preferences. This can be done for pairwise preferences, where a rater prefers sequence A to sequence B with some level of certainty, where the loss focuses on matching higher certainty preferences. Similarly, if single-trajectory (pointwise) reward labels are annotated, the loss can concentrate on fitting larger preferences better.

Matching losses can also be utilized in the regularizers of alignment optimizations. With this use, the link function can be designed to focus more on matching probability regions where it is more important for the target to be close to the reference, and focus less on matching regions of smaller importance. Specifically, unlike f-divergences, matching losses can focus on increasing losses for large probabilities, and decreasing for smaller ones. This would enhance regularization to make the target closer to the reference if the reference is a large probability, and would discount the regularization if the reference has a small probability. Asymmetric designs can also change the loss to depend on the reference probability. For example, for low reference, the loss can have a rather flat loss curve, which will allow the target to take any values, and for a high reference probability, the loss can have a steep curve, which will force the target to be close to the reference.

Current alignment regularizers attempt to match the target per-sequence probability to the reference one using some distance measure such an f-divergence or an Lₚ norm. Instead of matching the per-sequence target probability to the reference, when applied in a pairwise preference model, a regularizer that is less constrained can be applied on the probability, logit score, or other differences between two sequences in a pair, and match those of the target to those of the reference. Unlike f-divergences, matching losses can be easily applied to these differences, and link functions can be designed to give preferences to some regions of differences, for example, to large differences over smaller ones.

### Example Alignment Setting

A sequence processing model can be or have been pre-trained on a large corpus of data, resulting in a reference model. The reference model may in some cases be additionally anchored to a representative dataset by an additional Supervised Fine-Tuning (SFT) stage of training on that dataset.

In some implementations, in response to some prompt x, the reference model samples a sequence y of tokens of some maximum length T, where each token takes values v∈V in a vocabulary of |V|=M tokens. The reference model can define a probability mass function (based on some policy) π_{ref}(y|x), giving a conditional probability of the sample sequence y conditioned on the prompt x. For brevity, the remainder of the discussion omits the conditioning on x in the notation, but it should be understood that probabilities (and constraints) can be computed conditioned on the prompt x.

Reward fine-tuning to align the model to a specific task, which is generally represented or specified by reward or preference labels, can be applied by training a reward model on sequences, pairs, lists or sets of sequences, and then (iteratively) refining (fine-tuning) the model towards the reward model.

Different types of reward models can be trained. This discussion generally focuses on pairwise and pointwise (single-trajectory) rewards or preferences. In the classical RLHF setup, preference labels are given on a pair of sequences, sampled by the reference model in response to the same prompt. The preference labels indicate that one of the two sequences y_{w} is preferred over the other yₗ, and sometimes also what is the fraction of cases of preferring y_{w} over yₗ. In the pointwise (single-trajectory) setup, reward labels can indicate a positive (e.g., thumbs-up) or negative (e.g., thumbs-down) preference to a sequence y. In the exposition, the focus is on interpreting single-trajectory labels as probabilities of preferring the sequence. However, such scores can also be viewed as rewards to the sequence, which can be in any range. The techniques discussed can apply in either case.

Denote the per-sequence y preference label by z. The preference labels for a preferred and a non-preferred sequences, y_{w} and yₗ, respectively, are z_{w} and zₗ. We can also consider the preference label between sequences yᵢ and yⱼ as zᵢⱼ, where specifically for y_{w} and yₗ, we use z_{wl}. In many cases, z∈{0,1}, but we can also consider a case of fractional preference labels p∈[0,1], replacing the Bernoulli labels z. (More generally, preference labels can be in a different domain.)

Let the sequence processing model be denoted by the learned parameter vector θ∈Θ from the parameter space Θ. The model learns a policy π_{θ}(·), which is used to predict the probability π_{θ}(y) of a sequence y (conditioned on the prompt x). The pre-trained reference model uses a reference policy π_{ref}(y) to predict the probability of the sequence y. The target parameters θ can also be used to predict the probability of a positive preference label p_{θ}(z=1|y)=\hat{p} conditioned on the sequence y. For a preferred sequence y_{w} and nonpreferred sequence yₗ in a pair of sequences, we also define \hat{p}_{w}=p_{θ}(z_{w}=1|y_{w}) and \hat{p}ₗ=p_{θ}(zₗ=1|yₗ), respectively. When fractional labels are annotated, the respective “true” fractional preference labels are p, p_{w}, and pₗ. For both “true” preference labels and predicted preference labels, we define the “true” logit scores r, r_{w}, rₗ, and predicted logit scores, \hat{r}, \hat{r}_{w}, \hat{r}ₗ, respectively, where the mapping from logit scores to probabilities is given by

$$r = log ( p ) - log ( 1 - p ) , \qquad ( 1 )$$

$$p = \frac{1}{1 + exp ( - r )} = σ ( r )$$

and σ(·) denotes the logistic (Sigmoid) function. More generally, we can consider non-probabilistic labels for the different p variants, and non-logit rewards for the score r variants.

### Example General Alignment Framework

RLHF iteratively learns a preference (or reward) model, and then updates the sequence processing model's target distribution to one that maximizes the reward but is constrained to be close to the reference distribution (by a (reverse) KL divergence). DPO unifies the optimization by giving an analytical solution to the constrained reward maximization, which expresses the target distribution in terms of the reference and the reward function. The reward function is then expressed as a function of the reference and target distributions. A pairwise preference loss is used to fit the reward scores to human preference labels. Because the reward is now expressed in terms of the learnable target distribution, learning the preference scores actually updates the target distribution. Generalizing the DPO approach, a target policy optimization finds

$${π}_{θ} = arg {max}_{{π}_{θ}^{′}} \{ {𝔼}_{x \sim 𝒟 , y \sim {π}_{θ}^{′} ( y )} \{ ψ ( y ) \} - β {L}_{R} [ {π}_{θ}^{′} , {π}_{ref} ] \} \qquad ( 2 )$$

where ψ(y) is some function of the per-sequence reward, and L_{R}(π_{θ}, π_{ref}) is some regularizer loss that with strength β attempts to keep the target distribution close to the reference one. For DPO, ψ(y)=\hat{r}, and for IPO, ψ(y)=\hat{p}, where both \hat{r} and \hat{p} are prediction scores (logit and probability, respectively) of the model for the sequence y. For both DPO and IPO, the regularizer is the (reverse) KL-divergence D_{KL}(π_{θ}∥π_{ref}). The regularizer can, more generally, be any f-divergence or can take other alternative losses. As described later, matching losses (and Bregman divergences) can also be used.

The solution to the optimization problem in (2) must be constrained so that the target distribution satisfies the properties of a probability mass function, where all probabilities are nonnegative and sum up to 1 over all possible sequences. Negating the argument of (2), subtracting Lagrange multiplier constraint terms of λ·{Σy π_{θ}(y)−1} and of Σy α_{y}π_{θ}(y) constraining the probability equality and inequalities constraints, respectively, and differentiating with respect to π_{θ}(y) gives

$$β \cdot \frac{\partial {L}_{R} [ {π}_{θ} ( y ) , {π}_{ref} ( y ) ]}{\partial {π}_{θ} ( y )} - ψ ( y ) - λ - {α}_{y} = 0 \qquad ( 3 )$$

Applying the differentiation in (3), the target probability π_{θ}(y) can be expressed as a function of the reference probability, the reward function, and the Lagrange multipliers for every y. Recall that all probabilities are conditioned on the prompt x (that is omitted only for brevity), and also the Lagrange multipliers are functions of the prompt, λ=λ(x) and α_{y}=α_{y}(x). Applying the probability constraint, the multiplier λ can be expressed as a function of the reference distribution and the reward function (and in some cases also of the Karush-Kuhn-Tucker inequality constraints multipliers). The multiplier λ can be used to derive a normalizer partition function that normalizes the target probabilities π_{θ}(y) to sum to 1 over all values of y. Note that if the labels used for ψ(y) are probabilities, λ may need to provide a constant shift bias to balance between the reward and the regularizer, as usually the regularizers will tend to achieve a minimum of 0 distance between π_{θ}(y) and π_{ref}(y).

The inequality multipliers ay can be shown to equal 0 in many cases using the complementary slackness Karush-Kchun-Tucker condition. Namely, if the unconstrained solution for π_{θ}(y)>0, the condition is not necessary, and α_{y}=0. This can be shown to be the case for all y for a family of f-divergence regularizers, including the reverse KL-divergence, the direct KL-divergence (or cross entropy), Jeffreys' divergence, Shannon-Jensen divergence, and other regularizers. However, this is not always the case for other regularizers, such as Lₚ losses for p>1. For such regularizers, the optimization in (2), without the inequality constraints may lead to negative solutions for some values of y. This will require α_{y}>0 to constrain the target to π_{θ}(y)=0. However, to use Equation (3) for fine-tuning, it is first rearranged to express the reward function w (y) as a function of the target and reference, in order to optimize the target π_{θ}(y). Absorbing ay in w (y) by increasing the reward for values of y for which the target does not initially satisfy the constraint, changing the optimization problem, gives the same solution as the original problem; this time, a solution that satisfies all the constraints with α′_{y}=0. Thus the new problem can now be solved, as it gives the same solution as the original one, but now there is no practical need to consider the case of α_{y}>0.

In practice, the learned target distribution is a product of per token probabilities, of the tokens that constitute the sequence y, each computed with a softmax function over the token vocabulary. The softmax function constrains all token probabilities to exceed 0, and to sum to 1 over the vocabulary. Thus the computed probabilities are guaranteed to be bounded by 0 from below.

A caveat of ignoring non-zero Karush-Kuhn-Tucker multipliers is when ψ(y) is the probability of sequence y obtaining a positive preference label. Adding non-zero biases to some values of y may invalidate ψ(y) from being considered a probability, as it may exceed 1. This invalidates using a cross entropy loss to fit the reward to the human preference labels. However, other losses, such as a square loss, can still be used.

Rearranging the result in Equation (3) gives an expression for the reward score as a function of the target and reference probabilities

$$ψ ( y ) = β \cdot \frac{\partial {L}_{R} [ {π}_{θ} ( y ) , {π}_{ref} ( y ) ]}{\partial {π}_{θ} ( y )} - λ - {α}_{y} \qquad ( 4 )$$

To fit pointwise (single-trajectory) per-sequence reward labels, a loss can be applied on the right-hand-side of (4) relative to the labels describing ψ(y). If ψ(y) is a probability, the loss can be applied against the reward label p (or z, if binary). In this case, the multiplier λ should absorb a constant shift as the regularizer is centered at 0, but the probabilities are not. If ψ(y) is a logit, the loss can be applied against the logit score r expressing p in the logit domain as in (1), or the Sigmoid function can be used to convert ψ(y) to probability, and again the loss can be applied against the reward label. (Similarly, the loss can be applied to fit other reward functions in either domain.) The multiplier λ can be computed in theory by the constraint, and we can ignore multipliers ay assuming they are 0, where in cases they are not, α_{y} is absorbed in ψ(y). In practice, the use of Softmax to express π_{θ}(y) as a product of conditional token probabilities implicitly applies the constraint for λ, without an explicit need to compute it. (Explicit direct computation of λ is infeasible, as there is no access to all possible sequences y). The Softmax constraints, however, may interact differently with different losses.

To fit pairwise preference labels with an additive ψ(y), some example implementations can subtract the reward function for y, from that of y_{w}, giving

$$ψ ( {y}_{w} ) - ψ ( {y}_{l} ) = β \cdot \frac{\partial {L}_{R} [ {π}_{θ} ( {y}_{w} ) , {π}_{ref} ( {y}_{w} ) ]}{\partial {π}_{θ} ( {y}_{w} )} - β \cdot \frac{\partial {L}_{R} [ {π}_{θ} ( {y}_{l} ) , {π}_{ref} ( {y}_{l} ) ]}{\partial {π}_{θ} ( {y}_{l} )} \qquad ( 5 )$$

The multiplier λ cancels out. (This also implicitly cancels effects of Softmax constraints on the optimization.) If the targets for both sequences satisfy the inequality constraints, the multipliers α_{y} are also 0. Otherwise, they can be absorbed into the left-hand-side rewards, still giving (5) for the modified rewards. The right hand side of (5) can now be used to fit pairwise labels, with no need to explicitly compute normalizing distribution partition functions.

Fitting either pointwise (single-trajectory reward scores) or pairwise (sometimes referred to as preference) human preference labels, the framework in (2) gives three different degrees of freedom choices of: 1. The reward function ψ(·), 2. The regularizer L_{R}(π_{θ}, π_{ref}), and 3. The training loss that is used to fit the model in (4) for the pointwise case and in (5) for the pairwise one to the human labels.

For the pointwise case, ψ(·) can be, as in DPO, the logit score ψ(·)=\hat{r} learned for a positive sequence preference. It can also be, as in IPO, the probability ψ(·)=\hat{p} learned for a positive sequence preference. Other functions of the learned preference, such as ψ(·)=log (\hat{p}), can also be used. Additionally, reward scores that are not necessarily functions of probabilities can be used. Similar choices can be made in the pairwise case. These choices should ensure that the trained preference model is matched with the sequence generation model applied at decoding time using the learned target distribution. The generation model is typically applied as a single-trajectory (pointwise) model that generates a sequence independently of any other sequences. This imposes a restriction when applying models such as the Bradley-Terry one to express the probability p_{θ}(y_{w} >yₗ) that the model assigns to the event that y_{w} is preferred over yₗ. If ψ(·)=\hat{r} is used, the difference in (5) can be treated, as in DPO, as the logit score of the learned probability of preferring y_{w} over yₗ, giving

$${p}_{θ} ( {y}_{w} ≻ {y}_{i} ) = σ ( {\hat{r}}_{w} - {\hat{r}}_{l} ) = \frac{1}{1 + exp ( {\hat{r}}_{l} - {\hat{r}}_{w} )} \qquad ( 6 )$$

This, however, requires interpreting \hat{r}_{w} and \hat{r}ₗ as reward scores. If interpreted as individual sequence logit scores of positive preference probabilities of the two sequences; \hat{p}_{w} and \hat{p}ₗ, this model should be used only if labeling allows for ties between the sequences and the loss is applied only when there are no ties. This is because according to the generation model, ties may exist with a non-zero probability, and the pairwise training model should allow for such events. Keeping the binary preference interpretation of the generation model, alternatively, the modeled events of ties can be uniformly broken into the event of preferring y_{w} over yr and the event of preferring yₗ over y_{w}, giving

$${p}_{θ} ( {y}_{w} ≻ {y}_{l} ) = \frac{1}{2} \cdot ( 1 + {\hat{p}}_{w} - {\hat{p}}_{l} ) \qquad ( 7 )$$

The learned preference probability in (7) implies a choice of ψ(·)=\hat{p}, as in IPO.

The choice of the regularizer L_{R}(π_{θ}, π_{ref}) in (2) dictates the right hand sides of (4) in the pointwise case, and (5) in the pairwise case. KL-divergences, generalized f-divergences, and other forms can be used. The present disclosure shows that matching losses can also be used.

Finally, the last choice in the framework is that of the training loss to fit the learned preference scores implied by the target distribution, and expressed in (4) for the pointwise case and in (5) for the pairwise one, to the human preference labels. If we choose a square loss with a reward function ψ(·)=\hat{p}, we obtain a pointwise, single-trajectory, loss of

$${L}_{L 2 - ST} ( {π}_{θ} ; {π}_{ref} ) = {{𝔼}_{y \sim 𝒟} [ β \cdot \frac{\partial {L}_{R} [ {π}_{θ} ( y ) , {π}_{ref} ( y ) ]}{\partial {π}_{θ} ( y )} - λ - p ]}^{2} \qquad ( 8 )$$

where p is the pointwise per-sequence human reward label, and we absorb the coefficients α_{y} in the reward. The expectation is applied on the distribution of the fine-tuning dataset, which can be π_{ref}(·) or another distribution. We will use μ(y)=μ(y|x) to denote the probability of y under this distribution. The Lagrange multiplier can be taken out of the quadratic expression and be applied and optimized directly on the target, giving

$${L}_{L 2 - ST} ( {π}_{θ} ; {π}_{ref} ) = {{𝔼}_{y \sim 𝒟} [ β \cdot \frac{\partial {L}_{R} [ {π}_{θ} ( y ) , {π}_{ref} ( y ) ]}{\partial {π}_{θ} ( y )} - λ - p ]}^{2} + λ ( {\sum }_{y} {π}_{θ} ( y ) - 1 ) \qquad ( 9 )$$

where the learned λ in (9) may be different from the one in (8). With a probability label, a nonzero λ is required to shift the solution, because the quadratic term attempts to match an expectation of the probability to a regularizer that pushes towards 0. Instead, human labels can be centered at 0 by shifting [0,1] to

$$[ - \frac{1}{2} , \frac{1}{2} ] .$$

Depending on the regularizer, the losses in (8)-(9) may or may not recover the same optimum as directly optimizing (2). For example, with a reverse KL regularizer (as used in DPO and IPO), differentiating the losses with respect to π_{θ}(y) will multiply the linear gradient of the quadratic term in (9) by β/π_{θ}(y). This would lead to an optimal value of λ that is different from the one which is obtained by directly optimizing (2). Directly optimizing (2), however, may not be feasible because we do not have access to sequences other than the one we sample. Instead, a similar approach to the matching loss approach described below can be used, where a (different) loss is directly defined by defining only its gradient as a linear gradient, that does not include the β/π_{θ}(y) factor. Replacing the first term in (9) by such a loss will recover the same optimum as (2). It can be applied either with the Lagrange constraint, or directly without it, relying on Softmax logit scores constituting the probability π_{θ}(y), as demonstrated later.

Similarly, for a pairwise loss with a Bradley-Terry reward scoring and a square loss,

$${L}_{L 2 - pair - BT - prob} ( {π}_{θ} ; {π}_{ref} ) = {𝔼}_{( {y}_{w} - {y}_{l} ) \sim 𝒟} \{ {[ σ ( β \cdot \frac{\partial {L}_{R} [ {π}_{θ} ( {y}_{w} ) , {π}_{ref} ( {y}_{w} ) ]}{\partial {π}_{θ} ( {y}_{w} )} - β \cdot \frac{\partial {L}_{R} [ {π}_{θ} ( {y}_{l} ) , {π}_{ref} ( {y}_{l} ) ]}{\partial {π}_{θ} ( {y}_{l} )} ) - {p}_{wl} ]}^{2} \} \qquad ( 10 )$$

where p_{wl} is a human preference label between the preferred sequence and the non-preferred one, that can be binary or fractional. If p_{wl} is strictly fractional (p_{wl}∈(0,1)), an L₂ loss can be applied to fit the difference reward (logit) score to the logit score of the human pairwise label

$${L}_{L 2 - pair - BT - logit} ( {π}_{θ} ; {π}_{ref} ) = {𝔼}_{( {y}_{w} , {y}_{l} ) \sim 𝒟} \{ {[ ( β \cdot \frac{\partial {L}_{R} [ {π}_{θ} ( {y}_{w} ) , {π}_{ref} ( {y}_{w} ) ]}{\partial {π}_{θ} ( {y}_{w} )} - β \cdot \frac{\partial {L}_{R} [ {π}_{θ} ( {y}_{l} ) , {π}_{ref} ( {y}_{l} ) ]}{\partial {π}_{θ} ( {y}_{l} )} ) - {r}_{wl} ]}^{2} \} \qquad ( 11 )$$

where r_{wl} is the logit score for p_{wl}=σ(r_{wl}). With ψ(·)=\hat{p} and the model allowing ties,

$${L}_{L 2 - pair - BT - ipo} ( {π}_{θ} ; {π}_{ref} ) = {𝔼}_{( {y}_{w} , {y}_{l} ) \sim 𝒟} [ {( \frac{β}{2} \cdot \frac{\partial {L}_{R} [ {π}_{θ} ( {y}_{w} ) , {π}_{ref} ( {y}_{w} ) ]}{\partial {π}_{θ} ( {y}_{w} )} - \frac{β}{2} \cdot \frac{\partial {L}_{R} [ {π}_{θ} ( {y}_{l} ) , {π}_{ref} ( {y}_{l} ) ]}{\partial {π}_{θ} ( {y}_{l} )} + \frac{1}{2} - {p}_{wl} )}^{2} ] \qquad ( 12 )$$

Equation (10) recovers the gradient of DPO, but with a square loss instead of a cross-entropy one. Equation (11) matches DPO logits in the logit domain. Equation (12) is IPO.

The approach described applies the three choices in an offline supervised fine-tuning. In general, these three choices can also be applied to an online iterative RLHF. The regularizers in (9)-(12) can be replaced by a matching loss. The square loss in (9)-(12) can also be replaced by a matching loss. These choices are discussed further below. The focus is on the offline supervised fine-tuning approaches, following the path of DPO and IPO, as the framework described above, but such choices can also be applied in an online RLHF, where the reward model regularizer is replaced by a matching loss and/or the losses used to maximize reward and to train the preference/reward model against the human preference labels in RLHF are replaced by matching losses.

In particular, some example implementations of the present disclosure can be applied in or part of an offline method which combines all optimizations into one optimization. That optimization can be performed as a supervised offline sequence of sequence examples or example pairs training. The training can fit reward or preference scores to reward or preference labels (e.g., rewards in single-trajectory pointwise training and preference in pairwise training). Fitting the score updates a target distribution, which is a generative model distribution that is aimed at generating sequences. That target distribution is typically the only component optimized, as it is used to express a reward or preference score that is fit to the labels.

However, some example implementations can also be applied in the “classical” reinforcement learning RLHF setting. That setting is an online setting, where there are two models trained. At any point a reference model (e.g., which is the latest state of the target) is used a first time to generate sequences, which are scored with human rewards or preferences (or can be automatically generated or can be from a static dataset). These sequences and their labels are used to directly train a reward model (e.g., either contrastively or single-trajectory). Then, another second set of sequences are generated by the reference model. To these sequences, reward scores are produced by the current instantiation of the reward model (in some implementations, this stage is non-contrastive). A second optimization of the target generative model is now performed to maximize the reward, with anchoring (e.g., regularizer) to the reference model. This optimization is not applied to the reward model, it is applied to the generative model. For each sequence seen, the aim is to update the generative model so next time it can generate a sequence with larger reward (e.g., constrained by the regularizer to still stay close to the reference model, which is the current version of the target). This process repeats iteratively with both optimizations. In some example implementations applied in this setting, the matching loss is applied in both training the reward model and also when optimizing the target, when the fitting approach is considered. Additionally or alternatively, when the regularization approach is considered, the matching loss can be applied to anchor the target to the reference only in the second stage.

### Example Application of Matching Losses to Model Alignment

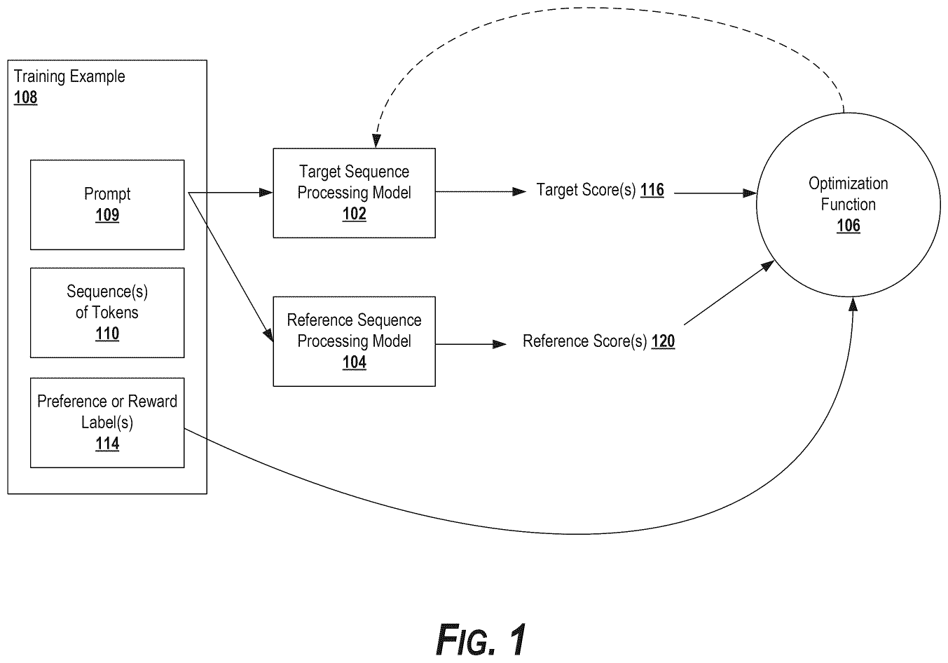

FIG. 1 illustrates a graphical diagram of an example alignment setting. In particular, FIG. 1 illustrates a target sequence processing model 102, a reference sequence processing model 104, and an optimization function 106. The target sequence processing model 102 can be trained using the optimization function 106 (e.g., as shown by the dashed line).

In some implementations, the reference sequence processing model 104 can be a pre-trained sequence processing model that has been trained on a large corpus of data. In some implementations, the reference sequence processing model 104 may have been further anchored to a representative dataset by an additional Supervised Fine-Tuning (SFT) stage.

In some implementations, at the start of the illustrated training process, the target sequence processing model 102 can be initialized from the reference sequence processing model 104. In other implementations, the target sequence processing model 102 may be a different model from the reference sequence processing model 104. For example, the target sequence processing model 102 may be a smaller model than the reference sequence processing model 104 (e.g., in terms of parameter count or other metric of model size).

In general, each of the target sequence processing model 102 and the reference sequence processing model 104 can respectively operate to process some input prompt x to sample or generate a sequence y of tokens of some maximum length T as an output, where each token in the output sequence takes values v∈V in a vocabulary of |V|=M tokens. For example, the reference sequence processing model 104 defines a probability function (based on some policy) π_{ref}(y|x) giving a conditional probability of the sample y conditioned on the prompt x. Likewise, the target sequence processing model 102 defines a probability function (based on some policy) π_{θ}(y|x) giving a conditional probability of the sample y conditioned on the prompt x. For brevity, the remainder of this description omits the conditioning on x, but it should be understood that probabilities are computed conditioned on an input or context.

Referring still to FIG. 1, a computing system can obtain a training example 108. The training example 108 can include or be associated with one or more sequences of tokens 110. The training example can include one or more reward or preference labels 114 that are respectively associated with the one or more sequences of tokens 110. The training example can also include a prompt 109 associated with the one or more sequences of tokens 110.

The computing system can process the prompt 109 with the target sequence processing model 102 to generate a target score 116. The target score 116 can be, for example, a probability output, a logit output, and/or some other output associated with the sequence of tokens 110. For example, in some implementations, the target score 116 can represent a conditional probability that the target sequence processing model 102 would generate the sequence of tokens 110 when conditioned on the prompt 109. If there are multiple sequences of tokens 110 contained in the training example 108 (e.g., a pair of sequences), then the target sequence processing model 102 can respectively process each sequence to generate a respective score 116 (e.g., a pair of target scores).

The computing system can process the prompt 109 with the reference sequence processing model 104 to generate a reference score 120. The reference score 120 can be, for example, a probability output, a logit output, and/or some other output associated with the sequence of tokens 110. For example, in some implementations, the reference score 120 can represent a conditional probability that the reference sequence processing model 104 would generate the sequence of tokens 110 when conditioned on the prompt 109. If there are multiple sequences of tokens 110 contained in the training example 108 (e.g., a pair of sequences), then the reference sequence processing model 104 can respectively process each sequence to generate a respective score 120 (e.g., a pair of reference scores).

The computing system can evaluate the optimization function 106 based on: (i) the reference score(s) 120 generated by a reference sequence processing model 104 for the one or more sequences of tokens 110 and (ii) a target score(s) 116 generated by a target sequence processing model 102 for the one or more sequences of tokens 110. For example, the optimization function 106 can include a reward or preference function that is fit to the one or more reward or preference labels 114 using a training loss function. For example, the reward or preference function can provide a predicted reward or preference score expressed in terms of both the reference score(s) 120 and the target score(s) 116. For example, the training loss function can be or include a matching loss function that evaluates an area under a monotonically-increasing (or monotonically non-decreasing) link function from a label value of the one or more reward or preference labels 114 to the predicted reward or preference score.

The computing system can modify one or more values of one or more parameters of the target sequence processing model 102 based on the optimization loss function 106. For example, this is illustrated in FIG. 1 via the dashed line. In some implementations, modifying the values of the parameters can include performing backpropagation based of the optimization loss function 106 (e.g., backpropagating a gradient of the optimization loss function 106).

In some implementations, the one or more sequences of tokens 110 comprise a single-trajectory sequence of tokens and the one or more reward or preference labels 114 comprise a pointwise reward label for the single sequence of tokens. In some of these implementations, the reward or preference score encoded in the optimization function 106 is a reward score expressed in terms of the reference score 120 and the target score 116. The matching loss function can be applied to fit the pointwise reward label of the single-trajectory sequence of tokens to the reward score.

In other implementations, the one or more sequences of tokens 110 comprise a pair of sequences of tokens and the one or more reward or preference labels 114 comprise a preference label for the pair of sequences of tokens. In some of these implementations, the reward or preference score encoded in the optimization function 106 comprises a preference score expressed in terms of the reference scores 120 and the target scores 116 for the pair of sequences of tokens. The matching loss function can be applied to fit the preference label of the pair of sequences of tokens to the preference score.

### Example Matching Losses

Let h(z) be a link function, which is used to define a matching loss. The matching loss attempts to match an estimate \hat{α} of the true activation a to the true activation α. The activation α can be a logit score, a probability, or any other statistics we are trying to match. The matching loss can be defined directly from its gradient with respect to the desired estimator

$${g}_{m} ( \hat{a} , a ) {=}^{Δ} \frac{\partial {L}_{match} ( \hat{a} , a )}{\partial \hat{a}} {=}^{Δ} h ( \hat{a} ) - h ( a ) \qquad ( 13 )$$

The gradient of the loss is simply the difference in values of the link function at the estimate and at the true value of the statistics, which can be a true label, which is observed and to which the model attempts to match a prediction.

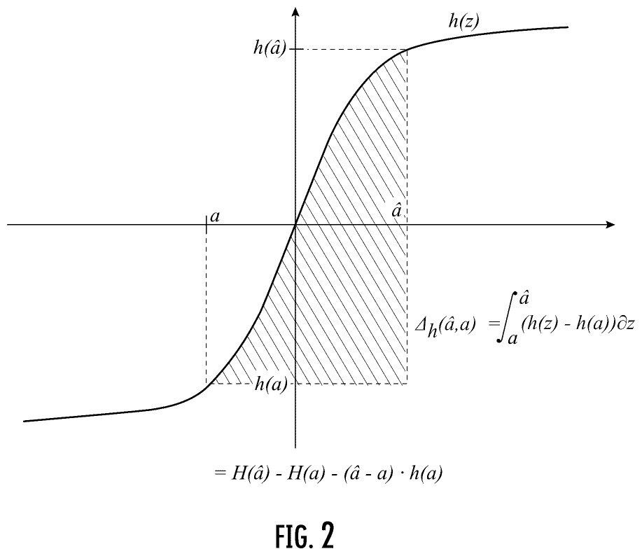

The actual loss is the integral on the link difference

$${L}_{match} ( \hat{a} , a ) = {\int }_{a}^{\hat{a}} ⌊ h ( z ) - h ( a ) ⌋ dz = H ( \hat{a} ) - H ( a ) - ( \hat{a} - a ) \cdot h ( a ) \qquad ( 14 )$$

where H(z) is the primitive antiderivative of the link h(z). Interestingly, the loss in (14) is the Bregman divergence, which is the difference between the function H(·) at \hat{α} and its first-order Taylor expansion around α. For a monotonic non-decreasing h(z), the loss gives the additional increase in area covered by the function from α to \hat{α}. This is illustrated in FIG. 2, which shows a matching loss as an area under the link function.

The simple form of the gradient of the matching loss gives an easy recipe to define losses according to different sensitivity requirements. Specifically, in regions in which the link is steep, a larger loss with a larger gradient is applied. In flat regions the loss is smaller. The simple definition of the loss in Equation (13) also gives a handle to directly determine the loss gradient, and even design losses for which the actual loss cannot be analytically expressed, but with a gradient that still satisfies desired sensitivity properties. Additionally, because the true label is known, the gradient in (13) and the loss can even be designed to be functions of the actual label value beyond the gradient dependence in the label through the link function; for example, a different link function can be used for a different label.

Examples of link functions include the identity, the sigmoid, and the exponential function

$$\begin{matrix}H ( z ) = z , & H ( z ) = σ [ α ( z + γ ) ] = \frac{1}{1 + {e}^{- α ( z + γ )}} , & H ( z ) = \frac{1}{α}\end{matrix} \cdot {e}^{α ( z + γ )} \qquad ( 16 )$$

The respective primitive functions are the square, the Softplus function and the exponent,

$$H ( z ) = \frac{{z}^{2}}{2} , H ( z ) = \frac{1}{α} \cdot log ( 1 + {e}^{α ( z + γ )} ) , H ( z ) = \frac{1}{α} \cdot {e}^{α ( z + γ )} \qquad ( 16 )$$

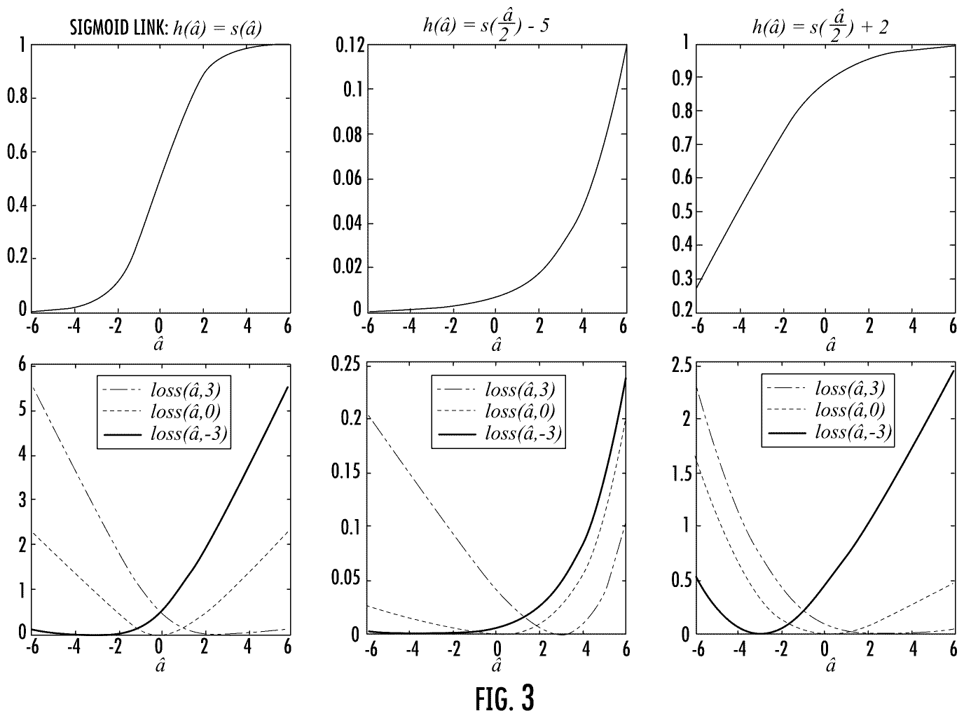

Thus the identity link gives a (standard) square loss. For the Sigmoid and the exponent, the parameters α and γ can determine on which region of the Sigmoid or exponent the loss focuses for the domain on which z is defined. If γ=0, the Sigmoid can give a temperature controlled cross entropy (CE) loss, which reduces to the standard CE loss with α=1. On the other hand, a shift of γ can determine the behavior of the loss in different regions, as illustrated in FIG. 3.

Specifically, FIG. 3 illustrates loss regions for example matching losses with different shifts of the Sigmoid link as function of a logit estimate \hat{α} of the activation α. The top row shows three different shifts of the Sigmoid. The bottom row shows respective matching losses for α=−3,0, 3.

FIG. 3 shows three different shifts of the Sigmoid on the top, and matching loss curves for each of these (on the bottom) for three (label) activation values α∈{−3,0,3}. The left link function (the standard unshifted Sigmoid) has a steep change in the center. This gives a strongly convex loss for the true label α=0. Due to the flat (noncompetitive) links on the left and the right, the losses to the left of α=−3 and to the right of α=3 are almost flat (as for the standard Sigmoid). Similar behavior is to the other sides initially, but as we move farther to the other sides, the loss increases due to transitioning through the steep region of the link. For the middle link, the loss for the large activation α=3 is large on both sides, due to the fast exponential increase of the link function. Losses for α=0 and α=−3 gradually become flatter around the minimum due to the gentler slopes in those regions. For the concave link on the right, the loss for α=−3 is steep, and as we move right, a mirror image of the behavior observed for the middle link is observed. The convex link in the center gives a larger loss to the right of the minimum at α=3 than the loss to its left. The concave link on the right is more sensitive to erring to the left of the minimum.

An important result of the behavior shown is that with exponentially increasing link functions one can design losses that focus heavily on distinguishing between large label values (or activities), and between large values and small ones. Yet, they can discount distinguishing among small label values. There can be a biased distribution of examples, where many examples have small labels. These labels become less distinguishable among themselves, but their presence calibrates the overall loss, by anchoring it to the low activity labels so that the low activity examples are not predicted as having high activity. The loss then distinguishes well between high activity labels, and between high and low activities, but not among low activities. This property can be leveraged for the fine-tuning problem. This behavior also differentiates asymmetric matching losses from losses which just scale the loss either by the true label, or by its estimate, for example, with a square loss. Scaling by the label value distinguishes well among high labels, and not between low labels. However, unlike an asymmetric matching loss, it does not suppress a high prediction of a low label. Scaling by the estimated label also distinguishes well in the high and not in the low value populations, but does not enhance the loss on a low estimate of a high true label. Matching losses can also be combined with either of these scaling.

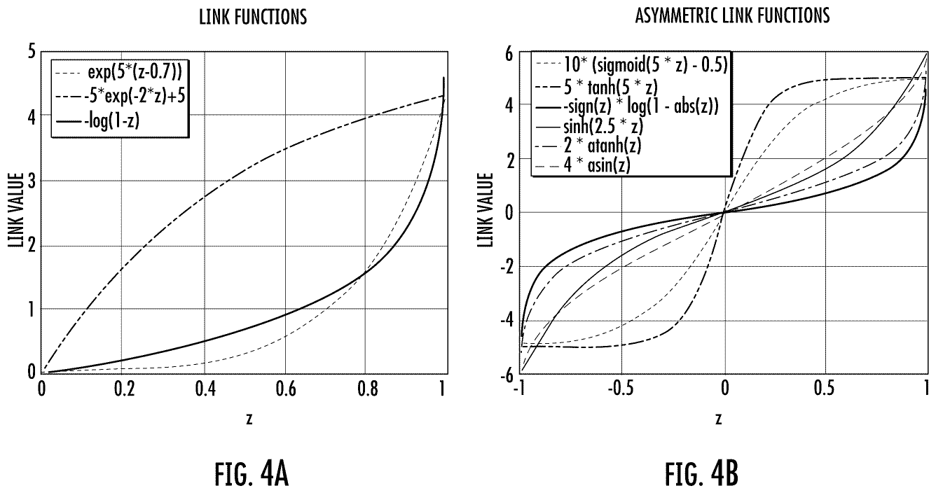

FIGS. 4A and 4B illustrate shifted and scaled (to fit the same axes) curves of example link functions. In particular, FIG. 4A illustrates example monotonic gradient link functions (scaled and shifted) for e^{z}, −log (1−z), and −e^{-z}. These links can be used to enhance losses in regions of high slope, and suppress regions of low slope. The convex ones emphasize the larger activation values. The concave one −e^{-z} flattens out at high activations, and can be used to limit the control of the growth of the estimate at the top of the high range. In the large slope range, it can give a similar behavior to the exponential link, except that the loss to the right of the true label becomes smaller than that to the left. Thus it can penalize underestimation better than the exponential curve, which penalizes overestimation higher.

FIG. 4B illustrates example asymmetric link functions of σ(z),

$$tanh ( z ) , - sign ( z ) \cdot log ( 1 - α \vert z \vert ) , sinh ( z ) ,$$

$$arc tanh ( z ) = \frac{1}{2} [ log ( 1 + z ) - log ( 1 - z ) ] ,$$

arcsin (z). The Sigmoid and the hyperbolic tangent are identical with correct scaling. Their competitive (high gradient region) is in the center. The center can be matched by shifting and scaling to the important activation region. The flatter regions at the extreme can help keep labels in a limited region suppressing outliers. The other functions enhance the extremes, enabling losses that directly emphasize high values, or extreme values, but also requiring other mechanisms to limit the exponential growth, such as clipping if necessary. The asymmetry of these curves can be useful for pairwise losses, where the magnitude of the label determines the sensitivity of the loss and not just its value.

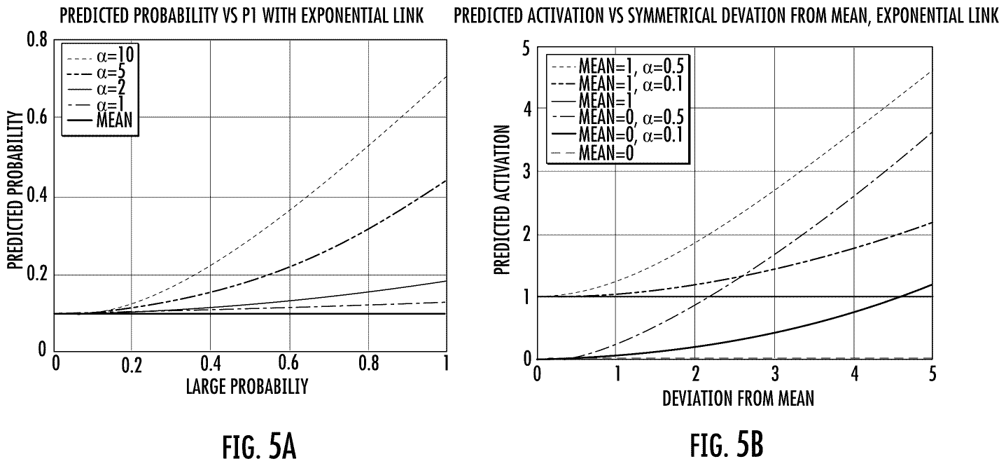

FIGS. 5A and 5B illustrate predicted expected label with an exponential link matching loss for two label values with the same expected mean label. FIG. 5A illustrates optimal prediction with the matching loss for one large label and n small labels as function of the large label with a fixed mean. FIG. 5B illustrates optimal matching loss prediction for one large label and one small label with increasing deviation from the mean as function of the deviation. In both FIGS. 5A and 5B, different temperatures of the exponential link are shown, and two different mean values are shown in FIG. 5B.

Thus, FIGS. 5A and 5B demonstrate how an exponential link focuses on large label values, introducing bias (which can be helpful) to prediction. In FIG. 5A, a population of labels with a single large label is observed, and potentially many small labels from two possible label values. The low label (probability) is 0.05, and the large label is greater, and takes the value of the x-axis. As the larger label value increases, the number of examples with the small label value increases (from 1 to 18), keeping the mean at 0.1. Applying an exponential link to the loss gives an estimate that increases with the larger probability. The higher the scaling factor α, the larger the deviation from the mean. In cases where the small label value is considered uncertain (or noisy), this behavior gives more emphasis to the certain high label value, especially if there are many “bad” uncertain labels, which we want to discount.

In FIG. 5B, the mean is kept fixed between two label values, one that goes down and the other that goes up by some fixed deviation from the mean shown on the x-axis. As the deviation from the mean increases, the larger label becomes larger and dominates the loss more, giving a prediction that increases as a function of the deviation. The increase is faster with a higher temperature a. This is shown for two different mean values. This also illustrates the shift parameter γ in (16). The shift changes the loss scale, but is fixed for all input values, and thus does not change the expected minimum of the loss.

Example Fitting Fractional (or Nonbinary) Preference Labels with Matching Losses

Asymmetric matching losses can be very useful for fitting both pointwise and pairwise preference labels. Pointwise (single-trajectory) asymmetric losses can provide focus on distinguishing and ranking among high preference sequences and between sequences with high preference and ones with low preferences, while discounting differences among unpreferred sequences that are not relevant to the target task. The effects of pairwise preference labels which show large differences between sequences can also be enhanced relative to potentially uncertain pairwise preference labels that indicate small differences between sequences, and can be discounted.

The benefits of asymmetric losses can be better leveraged when the model observes more label values, as with fractional labels. With only binary labels, asymmetric matching losses amount to emphasizing one label value over the other, effectively just biasing the loss towards the preferred label value. Similar effects can be achieved by just upscaling the loss for the preferred label value. With multiple (or continuous) label values, the benefits of asymmetric losses allow the model to distinguish better among labels in the competitive region with the higher slope of the link function, than in non-competitive regions with flatter links, that can be allocated to regions of smaller pairwise preferences.

This section next considers asymmetric losses for fitting pointwise (single trajectory) per-sequence labels. This is followed by considering the more common case of pairwise preference labels. The section concludes by describing how one can take further advantage of defining losses through the gradients expressed by the link function, further expanding the scope of asymmetric matching losses. This approach is specifically applied in the pointwise case.

### Example Pointwise (Single Trajectory) Fitting

Following the general alignment framework described earlier, and with some brevity, let

$$\hat{r} ( y ) {=}^{△} β \cdot \frac{\partial {L}_{R} [ {π}_{θ} ( y ) , {π}_{ref} ( y ) ]}{\partial {π}_{θ} ( y )} \qquad ( 17 )$$

be the estimate of the reward score ψ(y) obtained from the model, omitting the Lagrange constraining coefficients in Equation (4).

The estimate in (17) gives the reward function as a function of the reference probability of y and the target probability. The constraining Lagrange multipliers are omitted, but the loss can be optimized under the respective constraints. In practice, the constraints are resolved with the Softmax functions that produce the token probabilities of the tokens constituting the sequence y. The product of these probabilities gives the target π_{θ}(y). With some abuse of notation, let r(y) denote the pointwise human reward label, which is obtained in the same domain as the reward score ψ(y). If reward probability is used, then r(y)=p, if logit reward scores are used, r(y)=r. When using reward probabilities, example implementations can either offset the 0-centralized matching towards the regularizer leveraging the coefficient λ, or use labels shifted from [0,1] to [−0.5,0.5]. Other domains can be considered as well, including reward scores that are not mapped to probabilities. Similarly to the square loss in Equation (9), the estimate of the reward score can be matched with the matching loss in (14) to the labeled reward score, giving

$${L}_{MST} ( {π}_{θ} ; {π}_{ref} ) = {𝔼}_{y \sim 𝒟} \{ H [ \hat{r} ( y ) ] - H [ r ( y ) ] - [ \hat{r} ( y ) - r ( y ) ] \cdot h [ r ( y ) ] \} \qquad ( 18 )$$

where MST denotes “Matched Single Trajectory” loss. Similarly to the difference between DPO and IPO, (18) can be used to match the (same) regularizer, whose derivative with respect to π_{θ}(y) is in (17), to labels in different domains (e.g., probability, logit, or another).

A matching loss is easily defined through its gradient (13) with respect to the learned activation, which for the loss in (18) is given by

$$\frac{\partial {L}_{MST} ( {π}_{θ} ; {π}_{ref} )}{\partial \hat{r} ( y )} = μ ( y ) \cdot \{ h [ \hat{r} ( y ) ] - h [ r ( y ) ] \} \qquad ( 19 )$$

where μ(y)=μ(y|x) is the probability of the sequence y in the fine-tuning dataset. Applying the gradient relative to the model parameters across the dataset sequences gives

$$\frac{\partial {L}_{MST} ( {π}_{θ} ; {π}_{ref} )}{\partial θ} = {𝔼}_{y \sim 𝒟} \{ β \cdot \{ h [ \hat{r} ( y ) ] - h [ r ( y ) ] \} \cdot \frac{{\partial }^{2} {L}_{R} [ {π}_{θ} ( y ) , {π}_{ref} ( y ) ]}{\partial {π}_{θ} ( y ) \cdot \partial θ} \} \qquad ( 20 )$$

With the reverse KL regularizer, the derivative in (17) will include an additional constant term that can be absorbed in the equality constraint Lagrange multiplier. This constant can be offset by modifying the regularizer to D_{KL}(π_{θ}∥π_{ref})−Σπ_{θ}(y). Subtracting the additional term has no effect on the behavior, except mathematically offsetting the extra constant.

Using a generalized Sigmoid h(z)=σ[α(z+γ)] link with a reverse KL regularizer gives a matching loss gradient of

$$\frac{\partial {L}_{MST - sigmoid} ( {π}_{θ} ; {π}_{ref} )}{\partial θ} = β \cdot {𝔼}_{y \sim 𝒟} \{ [ σ ( α \cdot [ β \cdot log \frac{{π}_{θ} ( y )}{{π}_{ref} ( y )} + γ ] ) - σ ( α [ r ( y ) + γ ] ) ] \cdot \frac{\partial log {π}_{θ} ( y )}{\partial θ} \} \qquad ( 21 )$$

which can match the reward to fractional preference probabilities, that can be expressed as logits. With α≠1, a temperature controlled cross entropy loss is applied to optimize the target by fitting the rewards score. When γ≠0, unique to matching losses, an asymmetric loss is obtained depending on the scale and the shift, as shown in FIGS. 3A and 3B.

While it is natural to apply the loss in (21) in the logit domain, this loss can also be applied in the probability domain with ψ(y)=\hat{p}(and r(y)=p), or more generally in some reward domain expressed by the reward labels p. This is also a loss that is unique to the matching loss approach. The domain of probability labels is limited to [0,1] unlike the domain of the link function which is R. The choice of a and y can now completely dictate the behavior of the loss in the domain allowed for probability values. Different choices, e.g., illustrated in FIGS. 3A and 3B, can determine on which region of preference probabilities the loss is focused. Similar behavior can be obtained by picking h(z)=tanh(z) as the link function.

Using the Sigmoid link over a finite domain requires design of the scale and shift parameters (α and γ). The most likely use of the asymmetric losses for single-trajectory fine-tuning is to have a stronger loss for greater preference labels. This can be achieved by an exponential link function h(z)=exp (α(z+γ)). With a reverse KL regularizer, this gives a loss gradient of

$$\frac{\partial {L}_{MST - exp} ( {π}_{θ} ; {π}_{ref} )}{\partial θ} = β \cdot {𝔼}_{y \sim 𝒟} \{ [ {e}^{αγ} \cdot {[ \frac{{π}_{θ} ( y )}{{π}_{ref} ( y )} ]}^{αβ} - {e}^{α [ r ( y ) + γ ]} ] \cdot \frac{\partial log {π}_{θ} ( y )}{\partial θ} \} \qquad ( 22 )$$

Note from (22) that the shift γ does not play a role in the value of an unconstrained minimum, but can scale the gradient (and the loss) up or down. (As discussed in the last part of this section, applying the probability constraints can, in fact, change this behavior.) The loss with the gradient in (22) can be applied in the probability domain with r(y)=p, where the scale a can focus on different regions of the exponential function. Focusing on larger arguments enhances the loss for larger preference labels more significantly over the loss for smaller ones, discounting smaller preference labels more. The learned reward (exponentiating (17)) can be clipped if it exceeds some threshold for numerical stability. The loss in (22) can be applied for logit scores r(y)=r, but then should be clipped for some allowed range for numerical stability.

Matching losses with different link functions can be combined with regularizers other than the reverse KL one, including f-divergences and Lₚ losses. For example, when using an L₂ regularizer

$${L}_{R} = \frac{1}{2} {( {π}_{θ} ( y ) - {π}_{r e f} ( y ) )}^{2}$$

in either the probability or logit domains, the matching loss gradient with an exponential link is given by

$$\frac{\partial {L}_{MST - exp - L 2} ( {π}_{θ} ; {π}_{ref} )}{\partial θ} = β \cdot {𝔼}_{y \sim 𝒟} \{ [ exp ( α \cdot [ β \cdot ( {π}_{θ} ( y ) - {π}_{ref} ( y ) ) + γ ] ) - {e}^{α [ r ( y ) + γ ]} ] \cdot \frac{\partial {π}_{θ} ( y )}{\partial θ} \qquad ( 23 )$$

Other link functions may have different advantages. For example, a link function which is scaled and shifted to cover the relevant range from the negative negative-exponent −e^{-ax}, as shown in FIG. 4A, can have the benefit of gently tempering off either excessive predictions or excessive labels.

In some cases, it may be important, in addition to enhancing high preferences (e.g., strongly expressed positive preferences), to substantially suppress very low preferences (e.g., strongly expressed negative preferences). This can be the situation when the model should be fine-tuned to eliminate, for example, toxic responses to prompts. In such situations, it is not only important to focus on high positive preferences. It is also important to ensure suppression of highly negative preferences. Midrange human preferences can be viewed as more uncertain, and are thus less important to focus on. In such cases, link functions like h(z)=sinh(z), as shown in FIG. 4B, can be very useful, as they enhance the extremes but flatten the midrange. For the logit domain, such links are well aligned. To align them well with the probability domain, we can define

$$ψ ( y ) = \hat{p} - \frac{1}{2} and r ( y ) = p - \frac{1}{2}$$

to obtain symmetry around 0 before applying the loss. With the scaled and shifted h(z)=sinh(α(z+γ)) link and with the reverse KL regularizer, the gradient of the matching loss is given by

$$\frac{\partial {L}_{MST - sinh} ( {π}_{θ} ; {π}_{ref} )}{\partial θ} = \frac{β}{2} \cdot {𝔼}_{y \sim 𝒟} \{ [ {e}^{αγ} \cdot {[ \frac{{π}_{θ} ( y )}{{π}_{ref} ( y )} ]}^{αβ} - {e}^{- αγ} \cdot {[ \frac{{π}_{ref} ( y )}{{π}_{θ} ( y )} ]}^{αβ} - {e}^{α [ r ( y ) + γ ]} + {e}^{- α [ r ( y ) + γ ]} ] \cdot \frac{\partial log {π}_{θ} ( y )}{\partial θ} \qquad ( 24 )$$

Similarly to sinh(z), −sign (z) log (1−α|z|) and other links in FIG. 4B can be used. In the opposite case, where emphasis should be put on the midrange and not on the extremes, a temperature controlled Sigmoid can be used.

Single-trajectory fitting by matching losses can be enhanced in several additional directions. Scaling the loss as a function of the true label (or activation) and/or as a function of the predicted label (or activation) can put more emphasis on larger label and/or prediction values beyond the link function. Loss functions can be designed through(asymmetric) requirements on their gradients that can be expressed analytically, even if the loss function itself cannot be expressed analytically. For example, a loss can be applied on the logit domain but with gradients defined through a link function on the probability domain, with h(z)=σ(σ(z)) or h(z)=e^{σ(z)} where z is the logit score. Such a loss controls the logits, but is computed with the preference probabilities. One advantage is that if the exponential link is used, there is no need for capping the gradients, because the probability domain is capped, yet we can still attain the emphasis on high logit activations and the flattening of low ones.

### Example Pairwise (Preference) Fitting

To fit pairwise preference labels, the general framework described for pairwise loss can be followed similarly to the method described for fitting pointwise labels. As in (17), and following (5), a pairwise learned reward function is expressed in terms of the reference and target

$$\hat{r} ( {y}_{w} , {y}_{l} ) {=}^{△} \hat{r} ( {y}_{w} ) - \hat{r} ( {y}_{l} ) = β \cdot \frac{\partial {L}_{R} [ {π}_{θ} ( {y}_{w} ) , {π}_{ref} ( {y}_{w} ) ]}{\partial {π}_{θ} ( {y}_{w} )} - β \cdot \frac{\partial {L}_{R} [ {π}_{θ} ( {y}_{l} ) , {π}_{ref} ( {y}_{l} ) ]}{\partial {π}_{θ} ( {y}_{l} )} \qquad ( 25 )$$

The learned reward is a function of the derivatives of the regularizers, and as shown for (5), unlike the pointwise case, the Lagrange equality constraint coefficient cancels out. The pairwise probability label, that is fitted by (25), is given as a probability p_{wl}∈[0,1], designating the human level of preference of y_{w} over yₗ. Converting the probability to a logit score in Equation (1) gives the logit score r_{wl}. For consistent notation, some example implementations fit \hat{r}(y_{w},yₗ) to r(y_{w}, yₗ), which is defined as r(y_{w}, yₗ)=r_{wl} for logit score fitting, and as r(y_{w}, yₗ)=2p_{wl}−1 for probability fitting. This gives consistency between the two domains, where a positive score means that y_{w} is preferred over yₗ, and a negative one implies the opposite. It gives symmetry around 0 in both domains. It also allows using the same expressions to fit \hat{r}(y_{w}, yₗ) to r(y_{w}, yₗ) in both domains. In the logit domain, a logit difference is fit to the logit pairwise labels as in Equation (6). In the probability domain half the probability difference can be fit to a preference probability shifted left by half following Equation (7), where both sides are scaled by a factor of 2. Example descriptions herein focus on this probabilistic setup, however some example implementations can also incorporate more general reward scores, which can be mapped into either of the domains described above.

Similarly to the pointwise case (18), the matching loss that fits the pairwise difference is given by

$${L}_{MP} ( {π}_{θ} ; {π}_{ref} ) = {𝔼}_{( {y}_{w} , {y}_{l} ) \sim 𝒟} \{ H [ \hat{r} ( {y}_{w} , {y}_{l} ) ] - H [ r ( {y}_{w} , {y}_{l} ) ] - [ \hat{r} ( {y}_{w} , {y}_{l} ) - r ( {y}_{w} , {y}_{l} ) ] \cdot h [ r ( {y}_{w} , {y}_{l} ) ] \} \qquad ( 26 )$$

where MP denotes “Matched Pairwise”. Equation (26) is identical to (18), except that the learned reward score is the difference of the learned rewards for both sequences, and the label is a pairwise label describing the preference between the two sequences. Similarly to (19), the matching loss can be expressed through its gradient

$$\frac{\partial {L}_{MP} ( {π}_{θ} ; {π}_{ref} )}{\partial \hat{r} ( {y}_{w} , {y}_{l} )} = μ ( {y}_{w} , {y}_{l} ) \cdot \{ h [ \hat{r} ( {y}_{w} , {y}_{l} ) ] - h [ r ( {y}_{w} , {y}_{l} ) ] \} \qquad ( 27 )$$

As in (20), the gradient relative to the model parameters is

$$\frac{\partial {L}_{MP} ( {π}_{θ} ; {π}_{ref} )}{\partial θ} = {𝔼}_{( {y}_{w} , {y}_{l} ) \sim 𝒟} \{ β \cdot \{ h [ \hat{r} ( {y}_{w} , {y}_{l} ) ] - h [ r ( {y}_{w} , {y}_{l} ) ] \} \cdot [ \frac{{\partial }^{2} {L}_{R} [ {π}_{θ} ( {y}_{w} ) , {π}_{ref} ( {y}_{w} ) ]}{\partial {π}_{θ} ( {y}_{w} ) \cdot \partial θ} - \frac{{\partial }^{2} {L}_{R} [ {π}_{θ} ( {y}_{l} ) , {π}_{ref} ( {y}_{l} ) ]}{\partial {π}_{θ} ( {y}_{l} ) \cdot \partial θ} ] \} \qquad ( 28 )$$

Like DPO, the gradient with respect to the learned pairwise reward function is scaled by a difference of gradients of the regularizer gradient differentiated also with respect to the model parameters.

A linear link h(z)=z in (26)-(28) with a reverse KL regularizer in the probability domain and proper scaling gives (12). A linear link with respect to logits gives (11).

A general asymmetric loss can be applied similarly to (21) with a temperature controlled Sigmoid, which can also be shifted, giving

$$\frac{\partial {L}_{MP \cdot sigmoid} ( {π}_{θ} ; {π}_{ref} )}{\partial θ} = β \cdot {𝔼}_{( {y}_{w} , {y}_{l} ) \sim 𝒟} \{ [ σ ( α \cdot [ β \cdot ( log \frac{{π}_{θ} ( {y}_{w} )}{{π}_{ref} ( {y}_{w} )} - log \frac{{π}_{θ} ( {y}_{l} )}{{π}_{ref} ( {y}_{l} )} ) + γ ] ) - σ ( α [ r ( {y}_{w} , {y}_{l} ) + γ ] ) ] \cdot [ \frac{\partial log {π}_{θ} ( {y}_{w} )}{\partial θ} - \frac{\partial log {π}_{θ} ( {y}_{l} )}{\partial θ} ] \} \qquad ( 29 )$$

Shifting, however, breaks the symmetry on the pair, and will give some preference to the case that one sequence is preferred over the other. This can be done in cases where there is some reason to bias the pairwise preference. Such a reason can be if longer (or shorter) sequence responses are preferred over shorter (or longer) ones. The unshifted temperature controlled Sigmoid (or hyperbolic tangent) link gives preference to smaller magnitude pairwise difference labels, and suppresses extreme ones. Links like the hyperbolic sine, that have an exponential increase for positive values give larger losses to differences of larger magnitude.

Asymmetric link functions as h(z)=sinh(z) or others with similar properties, as shown in FIG. 4B, enhance losses when raters give more confident preferences to one sequence over the other. They discount lower magnitude, possibly less confident, pairwise preference scores. The asymmetry around 0 gives similar behavior on both sides, making the loss robust to permutation between the sequences. Consider, for example, the case described previously, where one rater prefers sequence A with score 0.7, and seven others prefer B with score 0.1. A proper loss would fit a neutral score of preferring one sequence over the other. Using an asymmetric loss with a hyperbolic sine link gives preference to A over B, which increases as α increases. Similarly to Equation (24), the pairwise matching loss with the hyperbolic sine link and with a reverse KL regularizer is given by

$$\frac{\partial {L}_{MP \cdot sinh} ( {π}_{θ} ; {π}_{ref} )}{\partial θ} = \frac{β}{2} \cdot {𝔼}_{( {y}_{w} , {y}_{l} ) \sim 𝒟} \{ [ {[ \frac{{π}_{θ} ( {y}_{w} )}{{π}_{ref} ( {y}_{w} )} \cdot \frac{{π}_{ref} ( {y}_{l} )}{{π}_{θ} ( {y}_{l} )} ]}^{α β} - {[ \frac{{π}_{ref} ( {y}_{w} )}{{π}_{θ} ( {y}_{w} )} \cdot \frac{{π}_{θ} ( {y}_{l} )}{{π}_{ref} ( {y}_{l} )} ]}^{αβ} - {e}^{α r ( {y}_{w} , {y}_{l} )} + {e}^{- α r ( {y}_{w} , {y}_{l} )} ] \cdot [ \frac{\partial log {π}_{θ} ( {y}_{w} )}{\partial θ} - \frac{\partial log {π}_{θ} ( {y}_{l} )}{\partial θ} ] \} \qquad ( 30 )$$

The equation can be expressed directly with the hyperbolic sine function as

$$\frac{\partial {L}_{MP \cdot sinh} ( {π}_{θ} ; {π}_{ref} )}{\partial θ} = β \cdot {𝔼}_{( {y}_{w} , {y}_{l} ) \sim 𝒟} \{ [ sinh [ αβ ( log \frac{{π}_{θ} ( {y}_{w} )}{{π}_{ref} ( {y}_{w} )} - log \frac{{π}_{θ} ( {y}_{l} )}{{π}_{ref} ( {y}_{l} )} ) ] - sinh [ α \cdot r ( {y}_{w} , {y}_{l} ) ] ] \cdot [ \frac{\partial log {π}_{θ} ( {y}_{w} )}{\partial θ} - \frac{\partial log {π}_{θ} ( {y}_{l} )}{\partial θ} ] \} \qquad ( 30 a )$$

Replacing the link in (30) by −sign (z)· log (1−α|z|), or by arctanh(αz) can enhance the behavior at extremities emphasizing the more confident preferences and discounting the less confident ones more (where arctanh(z) is applied only on z∈(−1,1), for example, for the mapping described above for the probability domain with fractional probability labels). The regularizer can be replaced by other regularizers as in the pointwise cases. For example, modifying (30) similarly to the modification of (22) to (23) would apply the pairwise loss with an L₂ regularizer.

A link function like sinh(·) when fitting pairwise labels can potentially be useful in addressing reward hacking. Reward hacking can be a critical problem in alignment, where the model locks itself to preferring one type of generation of a sequence over others. One conjecture is that reward hacking may be exacerbated by the solution to the optimization setup in Equation (2). With a reverse-KL regularizer and either a logit score (DPO) or a preference probability (IPO) reward function, this solution gives an exponential weighting to the reward function expressing the human preference, yet linear weighting to the reference prediction. The exponentiation of the reward enhances differences between preferred sequences and non-preferred ones, exponentially suppressing close competitors of the winner. This behavior may substantially reduce the competitiveness of good sequences that receive preference labels less favorable than the winning sequence, but can still be explored as reasonable responses to the prompt. Applying a sinh(·) or a similar link when fitting a pairwise label will flatten the fitting loss when the sequences receive close ratings, or in other words a weak preference to one over the other. Differentiating between two preferred sequences will only be significant if one is highly preferred over the other. Differentiating relative to poor sequences with larger magnitude human labels is still substantial as the loss increases with larger label differences.

Some example implementations may have access to pointwise labels or at least to trustable pointwise label predictions, and in some of such cases example implementations can use the average label of the two sequences to further the loss. Specifically, if both preference labels are small, even large differences between them should not matter, and the loss on the pair could be discounted. Another factor that can be used to scale preferences is other sequence trait preferences. For example, if short responses are preferred to long ones, the temperature of the loss on the side which describes preference of the short sequence could be increased, giving preference to that sequence.

### Example Direct Target Probability Gradient Fitting of Rewards

The methods described so far for fitting both single-trajectory and pairwise labels designed the matching loss utilizing the link function to define gradients with respect to the reward functions \hat{r}(y) and \hat{r}(y_{w}, yₗ) defined in (17) for the pointwise case and in (25) for the pairwise one, respectively. For many choices of link functions, with such gradients, an analytical expression can be derived for the actual matching loss with the antiderivative of the link. A major advantage of using matching losses is that they can be defined through their gradients even if no analytical expressions exist for the actual losses. To apply the loss, it is sufficient to differentiate by computing the gradients. This gives an extra flexibility in defining losses that can be more convenient to apply.

Instead of defining the loss through its gradient with respect to the reward function, it may be useful to define it directly with respect to the target sequence probability π_{θ}(y) in the pointwise case, and with respect to the target probabilities of both sequences π_{θ}(y_{w}) and π_{θ}(yₗ) in the pairwise case. This does require the existence of losses to which the gradients are defined. Such losses exist in the pointwise case. They allow us to improve the gradients with respect to the model parameters. Such losses may be better surrogates of the true objective, as defined in (2). Potentially, they can also reduce reward hacking. For example, with the reverse-KL regularizer, as shown in (22) and (24), the derivative with respect to π_{θ}(y) which scales the gradient is inversely proportional to the target probability.

This potentially increases gradients for smaller probabilities, possibly overcorrecting to the direction of the current label, potentially suppressing good potential candidate sequences fast when they are negatively labeled. Unfortunately, in the pairwise case, with some regularizers (such as the reverse-KL one), it may not be possible to obtain losses with better gradients than those described in (26)-(30) relative to both target probabilities. Therefore, the following discussion proceeds with the pointwise case where such losses are possible to design.

Similarly to (19), we can define

$$\frac{\partial {L}_{MSTT} ( {π}_{θ} ; {π}_{ref} )}{\partial {π}_{θ} ( y )} = h [ \ddot{r} ( y ) ] - h [ r ( y ) ] \qquad ( 31 )$$

where MSTT stands for “Matched Single-Trajectory Target”, inferring that the loss is defined with the gradient with respect to the target probability. In (31), the probability of y in the dataset was omitted, as we can define the loss per each y to be independent of the distribution of sequences in the training dataset (or weight it by 1/μ(y) which may be known). Empirically, the derivative with respect to the target sequence probability will be weighted uniformly for all fine-tuning dataset sequences, under the assumption that the support of the dataset is identical to that of the reference and target distributions. Similarly to (20), differentiation with respect to the model parameters gives

$$\frac{\partial {L}_{MSTT} ( {π}_{θ} ; {π}_{ref} )}{\partial θ} = {𝔼}_{y \sim 𝒟} \{ \frac{1}{μ ( y )} \cdot h [ \hat{r} ( y ) ] - h [ r ( y ) ] \} \cdot \frac{\partial {π}_{θ} ( y )}{\partial θ} \} \qquad ( 32 )$$

Instead of differentiating the derivative of the regularizer with respect to the model parameters as a factor that multiplies the loss in (31), the loss in (31) is now multiplied by the derivative of the target probability with respect to the model parameters. It follows that losses similar to those in (21)-(24) can be applied with the β multiplier omitted, and the derivative ∂log π_{θ}(y)/∂θ in (21), (22), and (24) replaced by ∂π_{θ}(y)/∂θ.

One consequence of this approach applies to the Lagrange constraints in applying a single-trajectory loss. Recall that a major step in deriving DPO relies on the cancellation of the partition function. Subsequent work, like IPO and other pairwise methods, also rely on this cancellation. This cancellation is similar to the cancellation of the Lagrange equality constraint, which is shown in Equation (5). It requires pairwise preference fitting. For single-trajectory methods, this constraint must be resolved in another way. Applying the Softmax function to generate probabilities of tokens that constitute the sequence y resolves the constraint. However, the loss used to fit labels is, in fact, a surrogate loss applied to maximize the optimization problem in Equation (2). In the case of a reverse-KL regularizer, it can be shown that the extra factor of ∂log π_{θ}(y)/∂π_{θ}(y)=1/π_{θ}(y), obtained for a single-trajectory IPO when applying an identity link with a probability identity reward to the loss in (20), does not match the solution of (2) because of the interaction of this extra factor with the equality constraint. Using the loss defined in (31)-(32) with the same reward, link and regularizer, on the other hand, can recover this optimum, which is the optimum of the true objective in (2).

A general solution to the loss in (31) can be derived by applying the (Lagrange, probability sum) equality constraint. It is then shown that using the Softmax to obtain the token probabilities of the tokens that constitute y can also recover the same solution. Define \hat{r}(y)=ƒ[π_{θ}(y)]. We use ƒ(·) to denote the reward function as a function of the target probability. (With some abuse of notation for notational convenience, we drop the notation for the dependence on the reference probability and the parameter β). With the Lagrange constraint, the optimality condition of (31) that can be used to find π_{θ}(y) is

$$h [ \hat{r} ( y ) ] - {𝔼}_{y \sim 𝒟} \{ h [ r ( y ) ] \} - λ = 0 \qquad ( 33 )$$

The expectation in (33) can be removed like in (31). We keep it only to express an expectation on the reward for the case that different samples of the same y receive different labels r(y). The expectation thus implies the expected link function for the different labels. For the optimization in (2), with an identity link, (33) reduces to \hat{r}(y)−Er(y)−λ=0. Resolving the constraints, as shown below, gives a solution to (2) with probability rewards and with logit rewards. Unlike single-trajectory IPO and DPO, both using a square loss, the solution is for the optimization in (2), as the matching loss duplicates the gradient of (2). It is not the solution to a surrogate problem, which as discussed, gives, with the additional differentiation factor, a solution that with the probability constraints does not match that of (2).

For simplicity, we continue by denoting the expectation term in (33) as Eh[r(y)]. Resolving (33) gives a solution to π_{θ}(y) as

$${π}_{θ} ( y ) = {f}^{- 1} \{ {h}^{- 1} [ 𝔼 h [ r ( y ) ] + λ ] \} \qquad ( 34 )$$

where ƒ⁻¹(·) is the inverse of ƒ(·), and h⁻¹(·) is the inverse of h(·). Applying the constraint, we can resolve λ

$$1 = {\sum }_{y} {π}_{θ} ( y ) = {\sum }_{y} {f}^{- 1} \{ {h}^{- 1} [ 𝔼 h [ r ( y ) ] + λ ] \} \qquad ( 35 )$$

The multiplier λ can be computed from (35) by applying the functions ƒ(·) and h(·). Then, (34) can be used to derive the target probability π_{θ}(y).

A similar derivation can be repeated replacing the Lagrange constraint by using a Softmax function for finding π_{θ}(y) to illustrate that in networks that produce token probabilities with the Softmax function, (31) can be optimized without worrying about the constraint, as the Softmax will apply a constraint. For such networks, the probability of each token constituting y is a Softmax taking the exponent of some logit score for that token, and normalizing it by the sum of exponents of the logit scores of all vocabulary tokens. The sequence probability is a product of these probabilities. Thus its numerator is an exponent of the sum of logit scores of each of the tokens. The normalization for each y may be different, but can be expressed as some common normalizer multiplied by an exponent of some adjustment. These adjustments can be applied to the numerators of all y sequences. The logarithms of the resulting numerators are the sequence logit scores. Denote the score of y as s(y). Differentiating (31) with respect to s(y) gives

$$\frac{\partial {L}_{MSTT} ( {π}_{θ} ; {π}_{ref} )}{\partial s ( y )} = {π}_{θ} ( y ) \cdot \{ h [ \hat{r} ( y ) ] - 𝔼 h [ r ( y ) ] - {\sum }_{{y}^{′}} {π}_{θ} ( {y}^{′} ) \cdot [ h [ \hat{r} ( {y}^{′} ) ] - 𝔼 h [ r ( {y}^{′} ) ] ] \} \qquad ( 36 )$$

This is because π^{θ}(y′) is also a function of s(y) for y≠y′. Equating (36) to 0 gives

$$h [ \hat{r} ( y ) ] - 𝔼 h [ r ( y ) ] = {\sum }_{{y}^{′}} {π}_{θ} ( {y}^{′} ) \cdot [ h [ \hat{r} ( {y}^{′} ) ] - 𝔼 h [ r ( {y}^{′} ) ] ] {=}^{Δ} S = λ \qquad ( 37 )$$

The first equality in (37) constrains each element of the link difference inside the sum to equal S resolving the equality constraint on the elements of π_{θ}(y) (directly from the Softmax function without using the Lagrange constrained optimization). The resulting equality is similar to (33) implying that S=λ. Thus the probability solution in (34) with the constraint equation in (35) applies also to the Softmax implementation of the optimization directly on (31).

For a reverse-KL regularizer,

$$f [ {π}_{θ} ( y ) ] = β log \frac{{π}_{θ} ( y )}{{π}_{r e f} ( y )} , and {f}^{- 1} ( r ) = {π}_{r e f} ( y ) \cdot {e}^{r / β} .$$

To reduce the matching loss to a square loss, h(z)=z. Applying these definitions to (35) gives

$$1 = {\sum }_{y} {π}_{ref} ( y ) \cdot exp [ \frac{1}{β} \cdot ( 𝔼 r ( y ) + λ ) ] \qquad ( 38 )$$

$$Yielding$$

$$λ = - β log \{ {\sum }_{y} {π}_{ref} ( y ) \cdot exp [ \frac{1}{β} \cdot 𝔼 r ( y ) ] \} \qquad ( 39 )$$

$$Substituting in ( 34 ) gives$$

$${π}_{θ} ( y ) = \frac{{π}_{ref} ( y ) \cdot exp [ \frac{1}{β} \cdot 𝔼 r ( y ) ]}{{\sum }_{{y}^{′}} {π}_{ref} ( {y}^{′} ) \cdot exp [ \frac{1}{β} \cdot 𝔼 r ( {y}^{′} ) ]} \qquad ( 40 )$$

As described, differentiating (2) with respect to π_{θ}(y) for a reverse-KL regularizer gives the solution in (40) as well. Thus the loss in (31)-(32) with an identity link and with a reverse-KL regularizer recovers the optimum of (2), which was assumed in the derivations of both(pairwise) DPO and IPO, each in its own domain of the reward function. This behavior is not true, as mentioned, for the loss in (19)-(20) with the same link and regularizer, and is also not the case for the square losses in (8)-(9) with the reverse-KL regularizer.

For a pairwise loss, as described before, a Sigmoid link with a reverse-KL regularizer applied in the logit domain recovers DPO which was derived by applying the solution for π_{θ}(y) in (40). However, because the inverse of the Sigmoid cannot distribute a sum of two arguments as in (34), in the pointwise case, (40) is not recovered. Instead, following (34), we obtain

$${π}_{θ} ( y ) = {π}_{ref} ( y ) \cdot {( \frac{𝔼 σ [ r ( y ) ] + λ}{1 - 𝔼 σ [ r ( y ) ] - λ} )}^{\frac{1}{β}} \qquad ( 41 )$$

The constraint λ must be evaluated numerically using (35). The cancellation of the partition function in the pairwise case allows DPO to use the relation in (40). However, with a Sigmoid link, it is not possible to recover the solution in (40) in the single-trajectory setting. As shown, a single-trajectory solution is possible, however, with an identity link applied on logit rewards scores as shown in (40).

Applying an exponential link to (31)-(32) still with a reverse-KL regularizer gives

$${π}_{θ} ( y ) = \frac{{π}_{ref} ( y ) \cdot 𝔼 \{ exp [ \frac{r ( y )}{β} ] \}}{{\sum }_{{y}^{′}} {π}_{ref} ( {y}^{′} ) \cdot 𝔼 \{ exp [ \frac{r ( {y}^{′} )}{β} ] \}} \qquad ( 42 )$$

Comparing (42) to (40) gives an interesting insight about asymmetric matching losses. The link leading to (40) gives a standard square loss which equally weighs reward labels. The target is an exponent of the expectation. With an exponential link asymmetric matching loss, the target is the expectation of the exponent. By Jensen's inequality, the latter is not smaller than the former. This demonstrates how the asymmetric loss pulls the probabilities towards the stronger labels relative to a square loss that does not. Note that in this case, there is a desire to recover (40) for large reward labels only, as the purpose of the exponential link is to obtain predictions that discount low reward labels, and focus on high ones. In many cases, one would expect the reward label r(y) to be a deterministic function of y. This is the case if there is a single rater or rate for a sequence in response to any prompt x. In this case, there should not be any difference between the solution in (42) and that in (40) for the optimal target π_{θ}(y) for any y. In practice, however, alignment only sees a handful of sequences y, and must generalize to other unseen sequences. Generalization averages over correlated sequences. In such averaging, sequences with larger losses dominate over ones with lower losses, utilizing the difference shown between (42) and (40) for the target distribution. Even in the deterministic case, where the solutions are equal, the loss leading to (42) will converge faster for sequences with larger preference labels, as its curve will be steeper than that of the symmetric (square) loss leading to (40). (The opposite will happen for small preferences, but those may be irrelevant.)

### Example Matching Loss Regularizers

Asymmetric matching losses can be used in alignment not only to fit the reward or preference labels, but also to regularize the target to the reference. A specific use case is when it is important to have sequences with high reference probabilities dominate the regularization, so that it is more important for the target to match the reference with high probabilities and less with lower sequence probabilities.

When considering sequence probabilities, matching the target to the reference probability of sequence y is applied in the probability domain. A multi-class version of matching losses is not feasible to consider because there is only access to a single or a pair of sequences at a time, thus a softmax cannot be updated on all possible sequence outcomes of a prompt. Some example implementations apply matching losses per-sequence, combined with the standard Lagrange probability constraints. In addition to applying the matching losses on full sequence probabilities, which consist of products of token probabilities, matching losses can be applied on the average per-token probability. The sequence or average token probabilities can also be converted to binary logit scores with Equation (1). The domain for the logit score of a sequence can be different from the standard domain because such scores can be highly negative due to long sequences. In such a case, the shift parameter y of a link function can be designed to capture the correct domain. Similarly, with very small probabilities of long sequences, the scaling parameter a can be tuned instead of using the average per-token probability.

For the regularization use, only the gradient of the loss relative to the target probability of the sequence is required as shown in Equations (4)-(5). Therefore, it is sufficient to express the regularization matching loss by its link function (or its gradient), which is sufficient to substitute the reward functions in (4)-(5).

### Example Per-Sequence Matching Loss Regularizers

Let hᵣ(z) be a regularizer link function. An asymmetric matching loss regularizer is given by

$$\frac{\partial {L}_{R - match} [ {π}_{θ} ( y ) , {π}_{ref} ( y ) ]}{\partial {π}_{θ} ( y )} = {h}_{r} [ {π}_{θ} ( y ) ] - {h}_{r} [ {π}_{ref} ( y ) ] \qquad ( 43 )$$

The link is a function of the full sequence probability. However, with the degrees of freedom in designing matching losses, the link function can be a function of the full sequence probability, its per-token average, or of a logit score to which the sequence or per-token probability is converted. Because there is no need to express the actual loss, Equation (43) can be applied to any of these cases, and the only important design criterion is to ensure that the design region of h(·) fits the range of the probability or logit values on which the link is applied.

From Equation (3),

$${π}_{θ} ( y ) = {h}_{r}^{- 1} \{ {h}_{r} [ {π}_{ref} ( y ) ] + \frac{1}{β} [ ψ ( y ) + λ + {α}_{y} ] \} \qquad ( 44 )$$

Absorbing the inequality constraints α_{y} in the reward ψ(y), as described earlier, gives an expression of the reward function in terms of the matching loss gradient of

$$ψ ( y ) = β \cdot \{ {h}_{r} [ {π}_{θ} ( y ) ] - {h}_{r} [ {π}_{ref} ( y ) ] \} - λ \qquad ( 45 )$$

for single-trajectory (pointwise) sequence losses, and a difference of reward functions of

$$ψ ( {y}_{w} ) - ψ ( {y}_{l} ) = β \cdot \{ {h}_{r} [ {π}_{θ} ( {y}_{w} ) ] - {h}_{r} [ {π}_{ref} ( {y}_{w} ) ] \} - β \cdot \{ {h}_{r} [ {π}_{θ} ( {y}_{l} ) ] - {h}_{r} [ {π}_{ref} ( {y}_{l} ) ] \} \qquad ( 46 )$$

for the sequence pairwise loss. Reformulating the Lagrange multiplier in (45) similarly to (9) gives a single-trajectory square loss with the matching loss regularizer of

$${L}_{L 2 - STM} ( {π}_{θ} ; {π}_{ref} ) = {𝔼}_{y \sim D} {\{ β \cdot \{ {h}_{r} [ {π}_{θ} ( y ) ] - {h}_{r} [ {π}_{ref} ( y ) ] \} - r ( y ) \}}^{2} + λ ( {\sum }_{y} {π}_{θ} ( y ) - 1 ) \qquad ( 47 )$$

Differentiating (47) with respect to π_{θ}(y) gives

$$\frac{\partial {L}_{L 2 - STM} ( {π}_{θ} ; {π}_{ref} )}{\partial {π}_{θ} ( y )} = 2 \cdot β \cdot μ ( y ) \cdot [ β \cdot \{ {h}_{r} [ {π}_{θ} ( y ) ] - {h}_{r} [ {π}_{ref} ( y ) ] \} - r ( y ) ] \cdot \frac{\partial {h}_{r} [ {π}_{θ} ( y ) ]}{\partial {π}_{θ} ( y )} + λ \qquad ( 48 )$$

To directly differentiate with respect to π^{θ}(y) as in (31)-(32) instead, the loss can be defined through its gradient as

$$\frac{\partial {L}_{STTM} ( {π}_{θ} ; {π}_{ref} )}{\partial {π}_{θ} ( y )} = β \cdot \{ {h}_{r} [ {π}_{θ} ( y ) ] - {h}_{r} [ {π}_{ref} ( y ) ] \} - r ( y ) + λ \qquad ( 49 )$$

where “ST™” stands for “Single-Trajectory Target Matched”. As in the losses based on (31), the loss in (49) avoids an extra differentiation of the regularizer with respect to the target probability π_{θ}(y) when using a matched loss regularizer.

Following (11), a pairwise square loss with a matching loss regularizer is given by

$${L}_{L 2 - PM} ( {π}_{θ} ; {π}_{ref} ) = {𝔼}_{( {y}_{w} , {y}_{l} ) \sim D} {\{ β \cdot [ {h}_{r} ( {π}_{θ} ( {y}_{w} ) ) - {h}_{r} ( {π}_{ref} ( {y}_{w} ) ) - {h}_{r} ( {π}_{θ} ( {y}_{l} ) ) + {h}_{r} ( {π}_{ref} ( {y}_{l} ) ) ] - r ( {y}_{w} , {y}_{l} ) \}}^{2} \} \qquad ( 50 )$$

As shown, the matching loss regularizer can be applied either for pointwise, single-trajectory losses, as in (47)-(49), or for sequence pairwise losses (50). With the matching loss, there are cases where non-zero inequality constraint coefficients must be absorbed into the reward function. However, they should not interfere with the method given the Softmax constraints on the token probabilities that constitute the sequence probability, and as long as the domain of the link function (before mapping to average probability or logits) contains the range of valid sequence probabilities.

An identity link function gives an L₂ regularizer in (47)-(50). With link hᵣ(z)=log [p/(1−p)] applied on per-sequence or average probabilities, the matching loss gradient is the difference of respective binary logit scores. This gives a regularizing loss like that of a binary KL divergence, which emphasizes on differences of extreme probabilities (either low or high). A similar loss is obtained when applying an identity regularizer on logit scores for the average per-token probabilities. An exponential link, or similar ones as in FIG. 4A, can be used to emphasize regularization of sequences with larger probabilities over sequences with low probabilities. Setting a flat region of a loss for low probability sequences can substantially discount their effect, yet, leveraging them to anchor the solution, because the loss will still penalize high predictions to such sequences. Finally, the regularization loss gradient can be scaled as a function of the reference probability to emphasize sequences with higher reference probabilities.

### Example Sequence Pair Matching Loss Regularizers

Instead of regularizing the target towards the reference, when fitting pairwise labels, some example implementations can regularize the difference, the ratio, the log-ratio, or other binary relation metrics between the preferred and non-preferred target sequence probabilities and those of the reference model. An asymmetric matching loss can focus on emphasizing matching large (or small, or both) differences between sequences, so the target model agrees with the reference about the differences when differences are large (or small, or both). Smaller differences can be discounted, or in the case of focusing on large and small differences, midrange differences can be discounted. Such an approach can be justified for enhancing dissimilarity or similarity between sequences. If one sequence is a common response to a prompt and another is not a reasonable response to the prompt, the difference of reference probabilities may be large, and in such a case, it is reasonable to preserve it large. In case of small differences, there may be cases in which it is unreasonable to diverge away from such differences, even if human labels give preference to one sequence over another. Regularizing the relation instead of each sequence probability provides some degree of freedom on the actual sequence probabilities.

Links such as the hyperbolic sine (unshifted) emphasize large difference magnitudes in either direction. Links like an unshifted Sigmoid emphasize on small magnitude differences. Links of a piecewise function with large slopes around 0 and at the extremes on both sides can emphasize both small and large magnitude differences. As in the pointwise regularization case, the link can be a function of the sequence probability, its per-token average, or a logit score of either.

The general form of mapping the regularizer to the reward function is given by

$$ψ ( {y}_{w} ) - ψ ( {y}_{l} ) = β \cdot \{ {h}_{r} [ {π}_{θ} ( {y}_{w} ) - {π}_{θ} ( {y}_{l} ) ] \} - β \cdot \{ {h}_{r} [ {π}_{ref} ( {y}_{w} ) - {π}_{ref} ( {y}_{l} ) ] \} \qquad ( 51 )$$

for a pair difference regularizer. For a ratio regularizer,

$$ψ ( {y}_{w} ) - ψ ( {y}_{l} ) = β \cdot {h}_{r} [ \frac{{π}_{θ} ( {y}_{w} )}{{π}_{θ} ( {y}_{l} )} ] - β \cdot {h}_{r} [ \frac{{π}_{ref} ( {y}_{w} )}{{π}_{ref} ( {y}_{l} )} ] \qquad ( 52 )$$

For a log-ratio regularizer,

$$ψ ( {y}_{w} ) - ψ ( {y}_{l} ) = β \cdot {h}_{r} [ log \frac{{π}_{θ} ( {y}_{w} )}{{π}_{θ} ( {y}_{l} )} ] - β \cdot {h}_{r} [ log \frac{{π}_{ref} ( {y}_{w} )}{{π}_{ref} ( {y}_{l} )} ] \qquad ( 53 )$$

which gives a general framework with different link functions.
Examples that Combine Preference Label Matching with Matching Loss Regularizers

The previous sections described matching losses for both fitting and regularizing in a general alignment framework. Fitting with matching losses can be done with any type of non-matching loss regularizers. Regularizing with matching losses can be applied with any fitting loss, such as cross entropy and square losses, although using CE may be limited due to the Lagrange inequality constraints. Both methods with matching losses can be combined, where both fitting and regularization are done with matching losses. These losses can use identical or different link functions.

Combining a single-trajectory matching loss with a matching loss regularizer gives a combined loss gradient of

$$\frac{\partial {L}_{MSTM ( {π}_{θ} ; {π}_{ref} )}}{\partial θ} = β \cdot {𝔼}_{y \sim D} \{ [ {h}_{f} \{ β \cdot ( {h}_{r} [ {π}_{θ} ( y ) ] - {h}_{r} [ {π}_{ref} ( y ) ] ) \} - {h}_{f} ( r ( y ) ) ] \cdot \frac{\partial {h}_{r} ( {π}_{θ} ( y ) )}{\partial θ} \} \qquad ( 54 )$$

where h_{f}(·) is the matching loss link function used for fitting the pointwise labels, and hᵣ(·) is the one used for regularizing the target probability towards the reference one. Applying the target gradient loss following (31), gives a modification of (54)

$$\frac{\partial {L}_{MSTTM ( {π}_{θ} ; {π}_{ref} )}}{\partial θ} = {𝔼}_{y \sim D} \{ \frac{1}{μ ( y )} \cdot [ {h}_{f} \{ β \cdot ( {h}_{r} [ {π}_{θ} ( y ) ] - {h}_{r} [ {π}_{ref} ( y ) ] ) \} - {h}_{f} ( r ( y ) ) ] \cdot \frac{\partial {π}_{θ} ( y )}{\partial θ} \} \qquad ( 55 )$$

where the derivative multiplying the fitting link difference is differentiating the target π_{θ}(y) instead of the regularization link with the target π_{θ}(y) being its argument.

Similarly, for fitting pairwise labels with a matching loss and regularizing with a pointwise matching loss, the gradient of the loss is given by,

$$\frac{\partial {L}_{MPM ( {π}_{θ} ; {π}_{ref} )}}{\partial θ} = β \cdot {𝔼}_{( {y}_{ω} , {y}_{l} ) \sim D} \{ [ {h}_{f} \{ β \cdot ( {h}_{r} [ {π}_{θ} ( {y}_{w} ) ] - {h}_{r} [ {π}_{ref} ( {y}_{w} ) ] - {h}_{r} [ {π}_{θ} ( {y}_{l} ) ] + {h}_{r} [ {π}_{ref} ( {y}_{l} ) ] ) \} - {h}_{f} ( r ( {y}_{w} , {y}_{l} ) ) ] \cdot [ \frac{\partial {h}_{r} ( {π}_{θ} ( {y}_{w} ) )}{\partial θ} - \frac{\partial {h}_{r} ( {π}_{θ} ( {y}_{l} ) )}{\partial θ} ] \} \qquad ( 56 )$$

Finally, with pairwise regularization instead of a pointwise one,

$$\frac{\partial {L}_{MPMP ( {π}_{θ} ; {π}_{ref} )}}{\partial θ} = β \cdot {𝔼}_{( {y}_{ω} , {y}_{l} ) \sim D} \{ [ {h}_{f} \{ β \cdot ( {h}_{r} [ {π}_{θ} ( {y}_{w} ) - {π}_{θ} ( {y}_{l} ) ] - {h}_{r} [ {π}_{ref} ( {y}_{w} ) - {π}_{ref} ( {y}_{l} ) ] ) \} - {h}_{f} ( r ( {y}_{w} , {y}_{l} ) ) ] \cdot [ \frac{\partial {h}_{r} ( {π}_{θ} ( {y}_{w} ) - {π}_{θ} ( {y}_{l} ) ]}{\partial θ} ] \} \qquad ( 57 )$$

### Example Methods

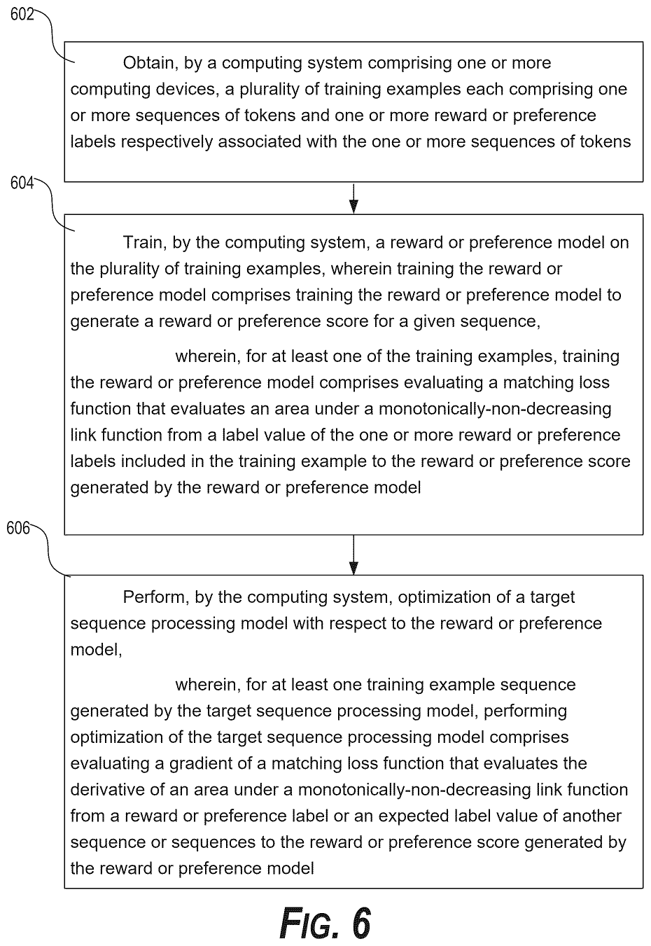

FIG. 6 presents a flowchart illustrating a computer-implemented method for performing reward or preference optimization. The method begins at step 602, where a computing system obtains a plurality of training examples. Each example can include one or more sequences of tokens alongside corresponding reward or preference labels.

Proceeding to step 604, the computing system trains a reward or preference model based on the acquired training examples. This training can include training the reward or preference model to accurately generate a reward or preference score for each sequence (e.g., to accurately predict the reward or preference label associated with each training example). Thus, in some examples, the generated scores aim to quantitatively represent the degree of reward or preference that human annotators associate with each sequence. The reward or preference model can thus learn to generate judgments in a form that can be leveraged for training of additional models.

According to an aspect of the present disclosure, at step 604 the training of the reward or preference model can include the use of a matching loss function. For example, the matching loss function can be used to fit the predictions of the reward or preference model to the reward or preference labels. As an example, training the reward or preference model can include evaluating a matching loss function that evaluates an area under a monotonically-non-decreasing link function from a label value of the one or more reward or preference labels included in the training example to the reward or preference score generated by the reward or preference model.

In step 606, the method performs optimization of a target sequence processing model relative to the trained reward or preference model. The target model generates new sequences, which are scored by the reward model, and then the target model is updated based on the generated scores. Performing this process iteratively allows the target model to adapt to generated sequences that produce larger reward scores of the reward model. In some implementations, step 606 can adapt also to maximize reward when data sequences are corrected with additional human input. In some implementations, at step 606, the target sequence processing model can also be regularized so as to not stray too far from a reference sequence processing model. In some instances, a matching loss can also be used in this regularization process, for example as described with respect to FIG. 6.

In some implementations, in the maximization of the reward in the target at step 606, target gradients can also be enhanced (or suppressed) by applying link functions on the reward scores. This helps to carry over the effects of the matching loss to the target distribution, because doing it only in the reward training only fixes a reward target. For example, there may be two online modes that can be performed at step 606. One mode takes the offline algorithm and applies it in each iteration. In this case, the same loss and gradient can be used as in the offline case. Another possible mode applies Proximal Policy Optimization (PPO) which uses the classical RL approach, and tries to maximize the reward by just applying a gradient on the target. In this mode, the matching loss will not be on any score of the target. The gradient is scaled by a difference between the reward score of the reward model and some reference, which in case we have multiple sequences is some function of the scores of the other sequences.

In particular, in some implementations, the optimization is performed at 606 using training example sequences generated by the target sequence processing model and, for at least one of the training example sequences generated by the target sequence processing model, performing optimization of the target sequence processing model includes evaluating a gradient of a matching loss function that evaluates the derivative of an area under a monotonically-non-decreasing link function from a reward or preference label or an expected label value of another sequence or sequences to the reward or preference score generated by the reward or preference model.

In some implementations, steps 604 and 606 can be performed in an alternating fashion for some number of iterations. For example, in a second or later iteration of step 604, the training examples used to update the reward model can include sequences generated by the target model for which labels are obtained. In other implementations, step 604 is performed only once.

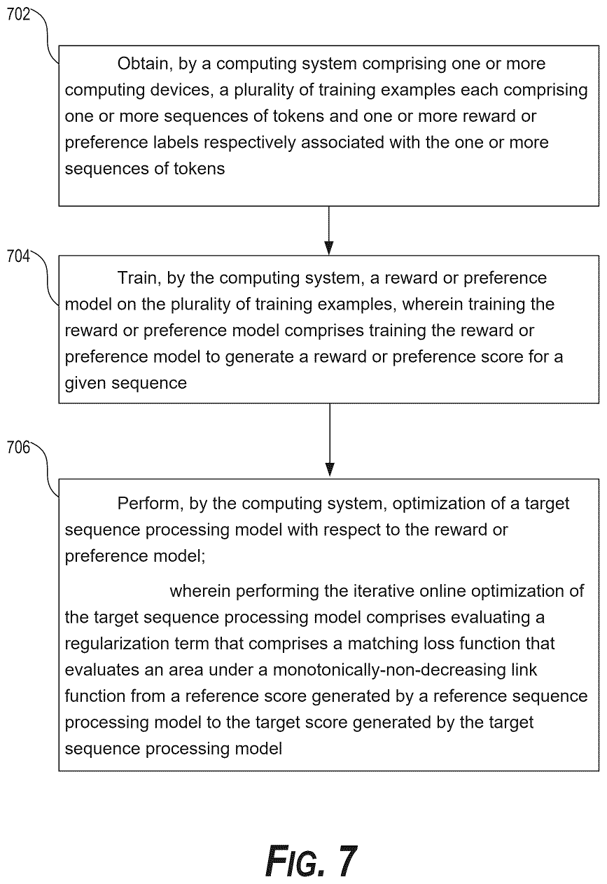

FIG. 7 presents a flowchart illustrating a computer-implemented method for performing reward or preference optimization. The method begins at step 702, where a computing system obtains a plurality of training examples. Each example can include one or more sequences of tokens alongside corresponding reward or preference labels.

Proceeding to step 704, the computing system trains a reward or preference model based on the acquired training examples. This training can include training the reward or preference model to accurately generate a reward or preference score for each sequence (e.g., to accurately predict the reward or preference label associated with each training example). Thus, in some examples, the generated scores aim to quantitatively represent the degree of reward or preference that human annotators associate with each sequence. The reward or preference model can thus encapsulate evaluative judgments in a form that can be computationally managed and utilized for further model adjustments.

In step 706, the computing system performs optimization of a target sequence processing model in relation to the previously trained reward or preference model. The target model is used to generate new training sequences that are scored (labeled) by the reward model. Then, these scores are used to update the target model so it can generate sequences with larger reward scores according to the current reward model. At step 706, the target sequence processing model can also be regularized so as to not stray too far from a reference sequence processing model.

More particularly, at step 706, the computing system can evaluate a regularization term to maintain the reliability and stability of the target model. This regularization term can include a matching loss function that assesses the area under a monotonically non-decreasing link function from a reference score generated by a reference sequence processing model to the target score generated by the target sequence processing model. Thus, the matching function can measure a discrepancy between the target score, generated by the target sequence processing model, and the reference score, produced by a reference sequence processing model. This regularization can ensure that while the target model is fine-tuned to align with the reward or preference model, it remains within a reasonable deviation from the reference model, preventing drastic deviations from expected behaviors.

In some implementations, steps 704 and 706 can be performed in an alternating fashion for some number of iterations. For example, in a second or later iteration of step 704, the training examples used to update the reward model can include sequences generated by the target model for which labels are obtained. In other implementations, step 704 is performed only once.

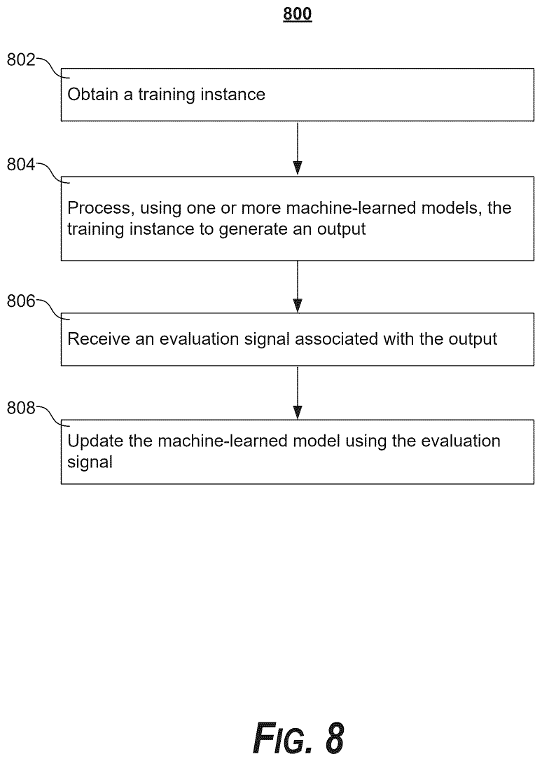

FIG. 8 depicts a flowchart of a method 800 for training one or more machine-learned models according to aspects of the present disclosure. For instance, an example machine-learned model can include a sequence processing model.

One or more portion(s) of example method 800 can be implemented by a computing system that includes one or more computing devices such as, for example, computing systems described with reference to the other figures. Each respective portion of example method 800 can be performed by any (or any combination) of one or more computing devices. Moreover, one or more portion(s) of example method 800 can be implemented on the hardware components of the device(s) described herein, for example, to train one or more systems or models. FIG. 8 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 8 is described with reference to elements/terms described with respect to other systems and figures for exemplary illustrated purposes and is not meant to be limiting. One or more portions of example method 800 can be performed additionally, or alternatively, by other systems.

At 802, example method 800 can include obtaining a training instance. A set of training data can include a plurality of training instances divided between multiple datasets (e.g., a training dataset, a validation dataset, or testing dataset). A training instance can be labeled or unlabeled. Although referred to in example method 800 as a “training” instance, it is to be understood that runtime inferences can form training instances when a model is trained using an evaluation of the model's performance on that runtime instance (e.g., online training/learning). Example data types for the training instance and various tasks associated therewith are described throughout the present disclosure.

At 804, example method 800 can include processing, using one or more machine-learned models, the training instance to generate an output. The output can be directly obtained from the one or more machine-learned models or can be a downstream result of a chain of processing operations that includes an output of the one or more machine-learned models.

At 806, example method 800 can include receiving an evaluation signal associated with the output. The evaluation signal can be obtained using a loss function. Various determinations of loss can be used, such as mean squared error, likelihood loss, cross entropy loss, hinge loss, contrastive loss, or various other loss functions. The evaluation signal can be computed using known ground-truth labels (e.g., supervised learning), predicted or estimated labels (e.g., semi- or self-supervised learning), or without labels (e.g., unsupervised learning). The evaluation signal can be a reward (e.g., for reinforcement learning). The reward can be computed using a machine-learned reward model configured to generate rewards based on output(s) received. The reward can be computed using feedback data describing human feedback on the output(s).

At 808, example method 800 can include updating the machine-learned model using the evaluation signal. For example, values for parameters of the machine-learned model(s) can be learned, in some embodiments, using various training or learning techniques, such as, for example, backwards propagation. For example, the evaluation signal can be backpropagated from the output (or another source of the evaluation signal) through the machine-learned model(s) to update one or more parameters of the model(s) (e.g., based on a gradient of the evaluation signal with respect to the parameter value(s)). For example, system(s) containing one or more machine-learned models can be trained in an end-to-end manner. Gradient descent techniques can be used to iteratively update the parameters over a number of training iterations. In some implementations, performing backwards propagation of errors can include performing truncated backpropagation through time. Example method 800 can include implementing a number of generalization techniques (e.g., weight decays, dropouts, etc.) to improve the generalization capability of the models being trained.

In some implementations, example method 800 can be implemented for training a machine-learned model from an initialized state to a fully trained state (e.g., when the model exhibits a desired performance profile, such as based on accuracy, precision, recall, etc.).

In some implementations, example method 800 can be implemented for particular stages of a training procedure. For instance, in some implementations, example method 800 can be implemented for pre-training a machine-learned model. Pre-training can include, for instance, large-scale training over potentially noisy data to achieve a broad base of performance levels across a variety of tasks/data types. In some implementations, example method 800 can be implemented for fine-tuning a machine-learned model. Fine-tuning can include, for instance, smaller-scale training on higher-quality (e.g., labeled, curated, etc.) data. Fine-tuning can affect all or a portion of the parameters of a machine-learned model. For example, various portions of the machine-learned model can be “frozen” for certain training stages. For example, parameters associated with an embedding space can be “frozen” during fine-tuning (e.g., to retain information learned from a broader domain(s) than present in the fine-tuning dataset(s)). An example fine-tuning approach includes reinforcement learning. Reinforcement learning can be based on user feedback on model performance during use.

### Example Machine-Learned Models

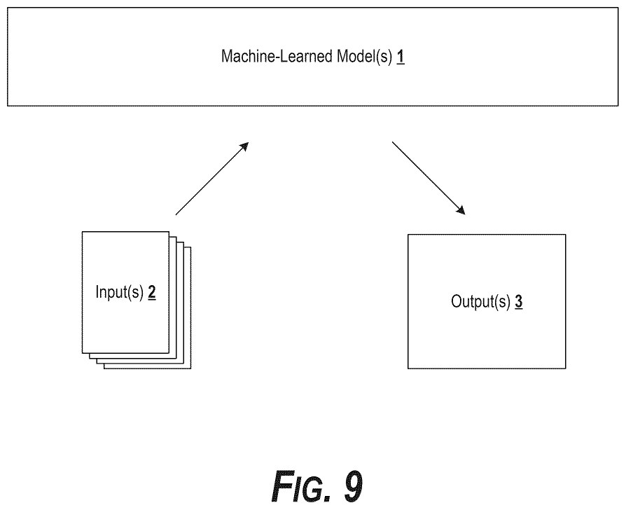

FIG. 9 is a block diagram of an example processing flow for using machine-learned model(s) 1 to process input(s) 2 to generate output(s) 3.

Machine-learned model(s) 1 can be or include one or multiple machine-learned models or model components. Example machine-learned models can include neural networks (e.g., deep neural networks). Example machine-learned models can include non-linear models or linear models. Example machine-learned models can use other architectures in lieu of or in addition to neural networks. Example machine-learned models can include decision tree based models, support vector machines, hidden Markov models, Bayesian networks, linear regression models, k-means clustering models, etc.

Example neural networks can include feed-forward neural networks, recurrent neural networks (RNNs), including long short-term memory (LSTM) based recurrent neural networks, convolutional neural networks (CNNs), diffusion models, generative-adversarial networks, or other forms of neural networks. Example neural networks can be deep neural networks. Some example machine-learned models can leverage an attention mechanism such as self-attention. For example, some example machine-learned models can include multi-headed self-attention models.

Machine-learned model(s) 1 can include a single or multiple instances of the same model configured to operate on data from input(s) 2. Machine-learned model(s) 1 can include an ensemble of different models that can cooperatively interact to process data from input(s) 2. For example, machine-learned model(s) 1 can employ a mixture-of-experts structure. See, e.g., Zhou et al., Mixture-of-Experts with Expert Choice Routing, ARXIV: 2202.09368v2 (Oct. 14, 2022).

Input(s) 2 can generally include or otherwise represent various types of data. Input(s) 2 can include one type or many different types of data. Output(s) 3 can be data of the same type(s) or of different types of data as compared to input(s) 2. Output(s) 3 can include one type or many different types of data.

Example data types for input(s) 2 or output(s) 3 include natural language text data, software code data (e.g., source code, object code, machine code, or any other form of computer-readable instructions or programming languages), machine code data (e.g., binary code, assembly code, or other forms of machine-readable instructions that can be executed directly by a computer's central processing unit), assembly code data (e.g., low-level programming languages that use symbolic representations of machine code instructions to program a processing unit), genetic data or other chemical or biochemical data, image data, audio data, audiovisual data, haptic data, biometric data, medical data, financial data, statistical data, geographical data, astronomical data, historical data, sensor data generally (e.g., digital or analog values, such as voltage or other absolute or relative level measurement values from a real or artificial input, such as from an audio sensor, light sensor, displacement sensor, etc.), and the like. Data can be raw or processed and can be in any format or schema.

In multimodal inputs 2 or outputs 3, example combinations of data types include image data and audio data, image data and natural language data, natural language data and software code data, image data and biometric data, sensor data and medical data, etc. It is to be understood that any combination of data types in an input 2 or an output 3 can be present.

An example input 2 can include one or multiple data types, such as the example data types noted above. An example output 3 can include one or multiple data types, such as the example data types noted above. The data type(s) of input 2 can be the same as or different from the data type(s) of output 3. It is to be understood that the example data types noted above are provided for illustrative purposes only. Data types contemplated within the scope of the present disclosure are not limited to those examples noted above.

### Example Machine-Learned Sequence Processing Models

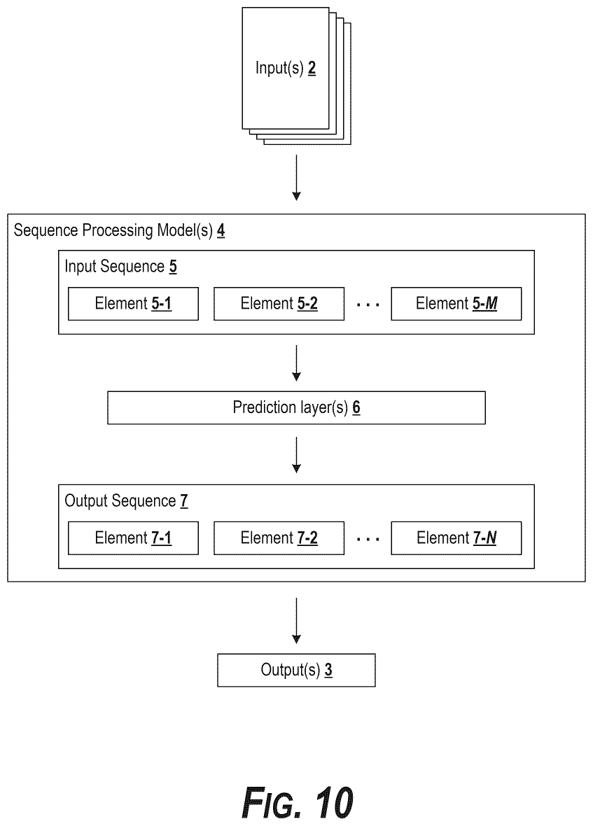

FIG. 10 is a block diagram of an example implementation of an example machine-learned model configured to process sequences of information. For instance, an example implementation of machine-learned model(s) 1 can include machine-learned sequence processing model(s) 4. An example system can pass input(s) 2 to sequence processing model(s) 4. Sequence processing model(s) 4 can include one or more machine-learned components. Sequence processing model(s) 4 can process the data from input(s) 2 to obtain an input sequence 5. Input sequence 5 can include one or more input elements 5-1, 5-2, . . . , 5-M, etc. obtained from input(s) 2. Sequence processing model 4 can process input sequence 5 using prediction layer(s) 6 to generate an output sequence 7. Output sequence 7 can include one or more output elements 7-1, 7-2, . . . , 7-N, etc. generated based on input sequence 5. The system can generate output(s) 3 based on output sequence 7.

Sequence processing model(s) 4 can include one or multiple machine-learned model components configured to ingest, generate, or otherwise reason over sequences of information. For example, some example sequence processing models in the text domain are referred to as “Large Language Models,” or LLMs. See, e.g., PaLM 2 Technical Report, GOOGLE, https://ai.google/static/documents/palm2techreport.pdf (n.d.). Other example sequence processing models can operate in other domains, such as image domains, see, e.g., Dosovitskiy et al., An Image is Worth 16×16 Words: Transformers for Image Recognition at Scale, ARXIV: 2010.11929v2 (Jun. 3, 2021), audio domains, see, e.g., Agostinelli et al., MusicLM: Generating Music From Text, ARXIV: 2301.11325v1 (Jan. 26, 2023), biochemical domains, see, e.g., Jumper et al., Highly accurate protein structure prediction with AlphaFold, 596 Nature 583 (Aug. 26, 2021), by way of example. Sequence processing model(s) 4 can process one or multiple types of data simultaneously. Sequence processing model(s) 4 can include relatively large models (e.g., more parameters, computationally expensive, etc.), relatively small models (e.g., fewer parameters, computationally lightweight, etc.), or both.

In general, sequence processing model(s) 4 can obtain input sequence 5 using data from input(s) 2. For instance, input sequence 5 can include a representation of data from input(s) 2 in a format understood by sequence processing model(s) 4. One or more machine-learned components of sequence processing model(s) 4 can ingest the data from input(s) 2, parse the data into pieces compatible with the processing architectures of sequence processing model(s) 4 (e.g., via “tokenization”), and project the pieces into an input space associated with prediction layer(s) 6 (e.g., via “embedding”).

Sequence processing model(s) 4 can ingest the data from input(s) 2 and parse the data into a sequence of elements to obtain input sequence 5. For example, a portion of input data from input(s) 2 can be broken down into pieces that collectively represent the content of the portion of the input data. The pieces can provide the elements of the sequence.

Elements 5-1, 5-2, . . . , 5-M can represent, in some cases, building blocks for capturing or expressing meaningful information in a particular data domain. For instance, the elements can describe “atomic units” across one or more domains. For example, for textual input source(s), the elements can correspond to groups of one or more words or sub-word components, such as sets of one or more characters.

For example, elements 5-1, 5-2, . . . , 5-M can represent tokens obtained using a tokenizer. For instance, a tokenizer can process a given portion of an input source and output a series of tokens (e.g., corresponding to input elements 5-1, 5-2, . . . , 5-M) that represent the portion of the input source. Various approaches to tokenization can be used. For instance, textual input source(s) can be tokenized using a byte-pair encoding (BPE) technique. See, e.g., Kudo et al., SentencePiece: A simple and language independent subword tokenizer and detokenizer for Neural Text Processing, PROCEEDINGS OF THE 2018 CONFERENCE ON EMPIRICAL METHODS IN NATURAL LANGUAGE PROCESSING (System Demonstrations), pages 66-71 (October 31-Nov. 4, 2018), https://aclanthology.org/D18-2012.pdf. Image-based input source(s) can be tokenized by extracting and serializing patches from an image.

In general, arbitrary data types can be serialized and processed into input sequence 5. It is to be understood that element(s) 5-1, 5-2, . . . , 5-M depicted in FIG. 10 can be the tokens or can be the embedded representations thereof.

Prediction layer(s) 6 can predict one or more output elements 7-1, 7-2, . . . , 7-N based on the input elements. Prediction layer(s) 6 can include one or more machine-learned model architectures, such as one or more layers of learned parameters that manipulate and transform the input(s) to extract higher-order meaning from, and relationships between, input element(s) 5-1, 5-2, . . . , 5-M. In this manner, for instance, example prediction layer(s) 6 can predict new output element(s) in view of the context provided by input sequence 5.

Prediction layer(s) 6 can evaluate associations between portions of input sequence 5 and a particular output element. These associations can inform a prediction of the likelihood that a particular output follows the input context. For example, consider the textual snippet, “The carpenter's toolbox was small and heavy. It was full of ______.” Example prediction layer(s) 6 can identify that “It” refers back to “toolbox” by determining a relationship between the respective embeddings. Example prediction layer(s) 6 can also link “It” to the attributes of the toolbox, such as “small” and “heavy.” Based on these associations, prediction layer(s) 6 can, for instance, assign a higher probability to the word “nails” than to the word “sawdust.”

A transformer is an example architecture that can be used in prediction layer(s) 4. See, e.g., Vaswani et al., Attention Is All You Need, ARXIV: 1706.03762v7 (Aug. 2, 2023). A transformer is an example of a machine-learned model architecture that uses an attention mechanism to compute associations between items within a context window. The context window can include a sequence that contains input sequence 5 and potentially one or more output element(s) 7-1, 7-2, . . . , 7-N. A transformer block can include one or more attention layer(s) and one or more post-attention layer(s) (e.g., feedforward layer(s), such as a multi-layer perceptron).

Prediction layer(s) 6 can include other machine-learned model architectures in addition to or in lieu of transformer-based architectures. For example, recurrent neural networks (RNNs) and long short-term memory (LSTM) models can also be used, as well as convolutional neural networks (CNNs). In general, prediction layer(s) 6 can leverage various kinds of artificial neural networks that can understand or generate sequences of information.

Output sequence 7 can include or otherwise represent the same or different data types as input sequence 5. For instance, input sequence 5 can represent textual data, and output sequence 7 can represent textual data. Input sequence 5 can represent image, audio, or audiovisual data, and output sequence 7 can represent textual data (e.g., describing the image, audio, or audiovisual data). It is to be understood that prediction layer(s) 6, and any other interstitial model components of sequence processing model(s) 4, can be configured to receive a variety of data types in input sequence(s) 5 and output a variety of data types in output sequence(s) 7.

Output sequence 7 can have various relationships to input sequence 5. Output sequence 7 can be a continuation of input sequence 5. Output sequence 7 can be complementary to input sequence 5. Output sequence 7 can translate, transform, augment, or otherwise modify input sequence 5. Output sequence 7 can answer, evaluate, confirm, or otherwise respond to input sequence 5. Output sequence 7 can implement (or describe instructions for implementing) an instruction provided via input sequence 5.

Output sequence 7 can be generated autoregressively. For instance, for some applications, an output of one or more prediction layer(s) 6 can be passed through one or more output layers (e.g., softmax layer) to obtain a probability distribution over an output vocabulary (e.g., a textual or symbolic vocabulary) conditioned on a set of input elements in a context window. In this manner, for instance, output sequence 7 can be autoregressively generated by sampling a likely next output element, adding that element to the context window, and re-generating the probability distribution based on the updated context window, and sampling a likely next output element, and so forth.

Output sequence 7 can also be generated non-autoregressively. For instance, multiple output elements of output sequence 7 can be predicted together without explicit sequential conditioning on each other. See, e.g., Saharia et al., Non-Autoregressive Machine Translation with Latent Alignments, ARXIV: 2004.07437v3 (Nov. 16, 2020).

Output sequence 7 can include one or multiple portions or elements. In an example content generation configuration, output sequence 7 can include multiple elements corresponding to multiple portions of a generated output sequence (e.g., a textual sentence, values of a discretized waveform, computer code, etc.). In an example classification configuration, output sequence 7 can include a single element associated with a classification output. For instance, an output “vocabulary” can include a set of classes into which an input sequence is to be classified. For instance, a vision transformer block can pass latent state information to a multilayer perceptron that outputs a likely class value associated with an input image.

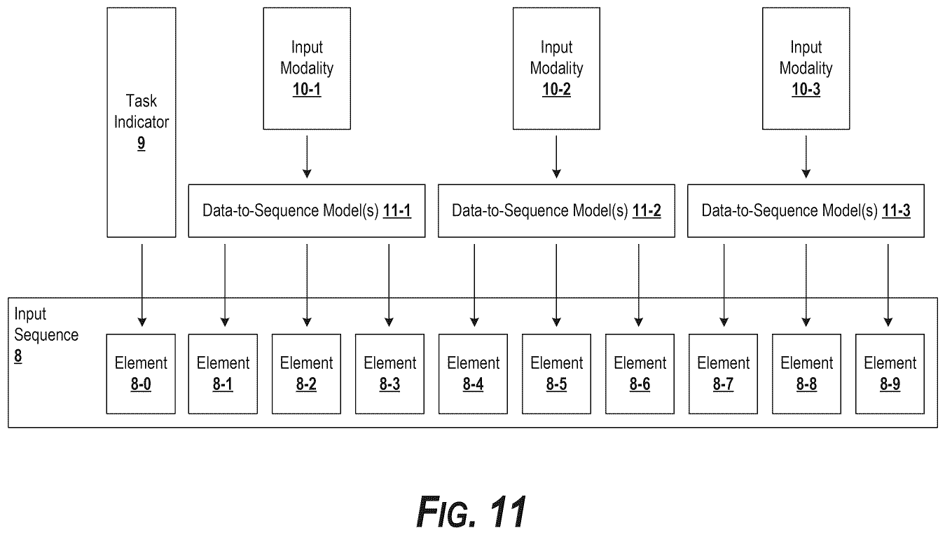

FIG. 11 is a block diagram of an example technique for populating an example input sequence 8. Input sequence 8 can include various functional elements that form part of the model infrastructure, such as an element 8-0 obtained from a task indicator 9 that signals to any model(s) that process input sequence 8 that a particular task is being performed (e.g., to help adapt a performance of the model(s) to that particular task). Input sequence 8 can include various data elements from different data modalities. For instance, an input modality 10-1 can include one modality of data. A data-to-sequence model 11-1 can process data from input modality 10-1 to project the data into a format compatible with input sequence 8 (e.g., one or more vectors dimensioned according to the dimensions of input sequence 8) to obtain elements 8-1, 8-2, 8-3. Another input modality 10-2 can include a different modality of data. A data-to-sequence model 11-2 can project data from input modality 10-2 into a format compatible with input sequence 8 to obtain elements 8-4, 8-5, 8-6. Another input modality 10-3 can include yet another different modality of data. A data-to-sequence model 11-3 can project data from input modality 10-3 into a format compatible with input sequence 8 to obtain elements 8-7, 8-8, 8-9.

Input sequence 8 can be the same as or different from input sequence 5. Input sequence 8 can be a multimodal input sequence that contains elements that represent data from different modalities using a common dimensional representation. For instance, an embedding space can have P dimensions. Input sequence 8 can be configured to contain a plurality of elements that have P dimensions. In this manner, for instance, example implementations can facilitate information extraction and reasoning across diverse data modalities by projecting data into elements in the same embedding space for comparison, combination, or other computations therebetween.

For example, elements 8-0, . . . , 8-9 can indicate particular locations within a multidimensional embedding space. Some elements can map to a set of discrete locations in the embedding space. For instance, elements that correspond to discrete members of a predetermined vocabulary of tokens can map to discrete locations in the embedding space that are associated with those tokens. Other elements can be continuously distributed across the embedding space. For instance, some data types can be broken down into continuously defined portions (e.g., image patches) that can be described using continuously distributed locations within the embedding space.

In some implementations, the expressive power of the embedding space may not be limited to meanings associated with any particular set of tokens or other building blocks. For example, a continuous embedding space can encode a spectrum of high-order information. An individual piece of information (e.g., a token) can map to a particular point in that space: for instance, a token for the word “dog” can be projected to an embedded value that points to a particular location in the embedding space associated with canine-related information. Similarly, an image patch of an image of a dog on grass can also be projected into the embedding space. In some implementations, the projection of the image of the dog can be similar to the projection of the word “dog” while also having similarity to a projection of the word “grass,” while potentially being different from both. In some implementations, the projection of the image patch may not exactly align with any single projection of a single word. In some implementations, the projection of the image patch can align with a combination of the projections of the words “dog” and “grass.” In this manner, for instance, a high-order embedding space can encode information that can be independent of data modalities in which the information is expressed.

Task indicator 9 can include a model or model component configured to identify a task being performed and inject, into input sequence 8, an input value represented by element 8-0 that signals which task is being performed. For instance, the input value can be provided as a data type associated with an input modality and projected along with that input modality (e.g., the input value can be a textual task label that is embedded along with other textual data in the input; the input value can be a pixel-based representation of a task that is embedded along with other image data in the input; etc.). The input value can be provided as a data type that differs from or is at least independent from other input(s). For instance, the input value represented by element 8-0 can be a learned within a continuous embedding space.

Input modalities 10-1, 10-2, and 10-3 can be associated with various different data types (e.g., as described above with respect to input(s) 2 and output(s) 3).

Data-to-sequence models 11-1, 11-2, and 11-3 can be the same or different from each other. Data-to-sequence models 11-1, 11-2, and 11-3 can be adapted to each respective input modality 10-1, 10-2, and 10-3. For example, a textual data-to-sequence model can subdivide a portion of input text and project the subdivisions into element(s) in input sequence 8 (e.g., elements 8-1, 8-2, 8-3, etc.). An image data-to-sequence model can subdivide an input image and project the subdivisions into element(s) in input sequence 8 (e.g., elements 8-4, 8-5, 8-6, etc.). An arbitrary datatype data-to-sequence model can subdivide an input of that arbitrary datatype and project the subdivisions into element(s) in input sequence 8 (e.g., elements 8-7, 8-8, 8-9, etc.).

Data-to-sequence models 11-1, 11-2, and 11-3 can form part of machine-learned sequence processing model(s) 4. Data-to-sequence models 11-1, 11-2, and 11-3 can be jointly trained with or trained independently from machine-learned sequence processing model(s) 4. Data-to-sequence models 11-1, 11-2, and 11-3 can be trained end-to-end with machine-learned sequence processing model(s) 4.

### Example Machine-Learned Model Development Platform

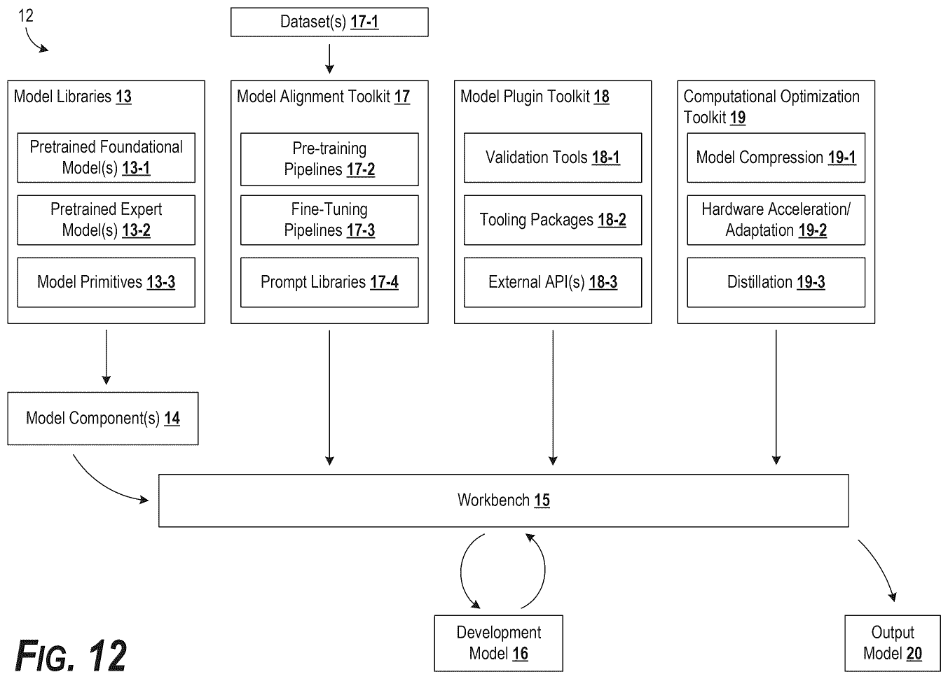

FIG. 12 is a block diagram of an example model development platform 12 that can facilitate creation, adaptation, and refinement of example machine-learned models (e.g., machine-learned model(s) 1, sequence processing model(s) 4, etc.). Model development platform 12 can provide a number of different toolkits that developer systems can employ in the development of new or adapted machine-learned models.

Model development platform 12 can provide one or more model libraries 13 containing building blocks for new models. Model libraries 13 can include one or more pre-trained foundational models 13-1, which can provide a backbone of processing power across various tasks. Model libraries 13 can include one or more pre-trained expert models 13-2, which can be focused on performance in particular domains of expertise. Model libraries 13 can include various model primitives 13-3, which can provide low-level architectures or components (optionally pre-trained), which can be assembled in various arrangements as desired.

Model development platform 12 can receive selections of various model components 14. Model development platform 12 can pass selected model components 14 to a workbench 15 that combines selected model components 14 into a development model 16.

Workbench 15 can facilitate further refinement and adaptation of development model 16 by leveraging a number of different toolkits integrated with model development platform 12. For example, workbench 15 can facilitate alignment of the development model 16 with a desired performance profile on various tasks using a model alignment toolkit 17.

Model alignment toolkit 17 can provide a number of tools for causing development model 16 to generate outputs aligned with desired behavioral characteristics. Alignment can include increasing an accuracy, precision, recall, etc. of model outputs. Alignment can include enforcing output styles, schema, or other preferential characteristics of model outputs. Alignment can be general or domain-specific. For instance, a pre-trained foundational model 13-1 can begin with an initial level of performance across multiple domains. Alignment of the pre-trained foundational model 13-1 can include improving a performance in a particular domain of information or tasks (e.g., even at the expense of performance in another domain of information or tasks).

Model alignment toolkit 17 can integrate one or more dataset(s) 17-1 for aligning development model 16. Curated dataset(s) 17-1 can include labeled or unlabeled training data. Dataset(s) 17-1 can be obtained from public domain datasets. Dataset(s) 17-1 can be obtained from private datasets associated with one or more developer system(s) for the alignment of bespoke machine-learned model(s) customized for private use-cases.

Pre-training pipelines 17-2 can include a machine-learned model training workflow configured to update development model 16 over large-scale, potentially noisy datasets. For example, pre-training can leverage unsupervised learning techniques (e.g., de-noising, etc.) to process large numbers of training instances to update model parameters from an initialized state and achieve a desired baseline performance. Pre-training pipelines 17-2 can leverage unlabeled datasets in dataset(s) 17-1 to perform pre-training. Workbench 15 can implement a pre-training pipeline 17-2 to pre-train development model 16.

Fine-tuning pipelines 17-3 can include a machine-learned model training workflow configured to refine the model parameters of development model 16 with higher-quality data. Fine-tuning pipelines 17-3 can update development model 16 by conducting supervised training with labeled dataset(s) in dataset(s) 17-1. Fine-tuning pipelines 17-3 can update development model 16 by conducting reinforcement learning using reward signals from user feedback signals. Workbench 15 can implement a fine-tuning pipeline 17-3 to fine-tune development model 16.

Prompt libraries 17-4 can include sets of inputs configured to induce behavior aligned with desired performance criteria. Prompt libraries 17-4 can include few-shot prompts (e.g., inputs providing examples of desired model outputs for prepending to a desired runtime query), chain-of-thought prompts (e.g., inputs providing step-by-step reasoning within the exemplars to facilitate thorough reasoning by the model), and the like.

Example prompts can be retrieved from an available repository of prompt libraries 17-4. Example prompts can be contributed by one or more developer systems using workbench 15.

In some implementations, pre-trained or fine-tuned models can achieve satisfactory performance without exemplars in the inputs. For instance, zero-shot prompts can include inputs that lack exemplars. Zero-shot prompts can be within a domain within a training dataset or outside of the training domain(s).

Prompt libraries 17-4 can include one or more prompt engineering tools. Prompt engineering tools can provide workflows for retrieving or learning optimized prompt values. Prompt engineering tools can facilitate directly learning prompt values (e.g., input element values) based one or more training iterations. Workbench 15 can implement prompt engineering tools in development model 16.

Prompt libraries 17-4 can include pipelines for prompt generation. For example, inputs can be generated using development model 16 itself or other machine-learned models. In this manner, for instance, a first model can process information about a task and output a input for a second model to process in order to perform a step of the task. The second model can be the same as or different from the first model. Workbench 15 can implement prompt generation pipelines in development model 16.

Prompt libraries 17-4 can include pipelines for context injection. For instance, a performance of development model 16 on a particular task can improve if provided with additional context for performing the task. Prompt libraries 17-4 can include software components configured to identify desired context, retrieve the context from an external source (e.g., a database, a sensor, etc.), and add the context to the input prompt. Workbench 15 can implement context injection pipelines in development model 16.

Although various training examples described herein with respect to model development platform 12 refer to “pre-training” and “fine-tuning,” it is to be understood that model alignment toolkit 17 can generally support a wide variety of training techniques adapted for training a wide variety of machine-learned models. Example training techniques can correspond to the example training method 700 described above.

Model development platform 12 can include a model plugin toolkit 18. Model plugin toolkit 18 can include a variety of tools configured for augmenting the functionality of a machine-learned model by integrating the machine-learned model with other systems, devices, and software components. For instance, a machine-learned model can use tools to increase performance quality where appropriate. For instance, deterministic tasks can be offloaded to dedicated tools in lieu of probabilistically performing the task with an increased risk of error. For instance, instead of autoregressively predicting the solution to a system of equations, a machine-learned model can recognize a tool to call for obtaining the solution and pass the system of equations to the appropriate tool. The tool can be a traditional system of equations solver that can operate deterministically to resolve the system of equations. The output of the tool can be returned in response to the original query. In this manner, tool use can allow some example models to focus on the strengths of machine-learned models—e.g., understanding an intent in an unstructured request for a task—while augmenting the performance of the model by offloading certain tasks to a more focused tool for rote application of deterministic algorithms to a well-defined problem.

Model plugin toolkit 18 can include validation tools 18-1. Validation tools 18-1 can include tools that can parse and confirm output(s) of a machine-learned model. Validation tools 18-1 can include engineered heuristics that establish certain thresholds applied to model outputs. For example, validation tools 18-1 can ground the outputs of machine-learned models to structured data sources (e.g., to mitigate “hallucinations”).

Model plugin toolkit 18 can include tooling packages 18-2 for implementing one or more tools that can include scripts or other executable code that can be executed alongside development model 16. Tooling packages 18-2 can include one or more inputs configured to cause machine-learned model(s) to implement the tools (e.g., few-shot prompts that induce a model to output tool calls in the proper syntax, etc.). Tooling packages 18-2 can include, for instance, fine-tuning training data for training a model to use a tool.

Model plugin toolkit 18 can include interfaces for calling external application programming interfaces (APIs) 18-3. For instance, in addition to or in lieu of implementing tool calls or tool code directly with development model 16, development model 16 can be aligned to output instruction that initiate API calls to send or obtain data via external systems.

Model plugin toolkit 18 can integrate with prompt libraries 17-4 to build a catalog of available tools for use with development model 16. For instance, a model can receive, in an input, a catalog of available tools, and the model can generate an output that selects a tool from the available tools and initiates a tool call for using the tool.

Model development platform 12 can include a computational optimization toolkit 19 for optimizing a computational performance of development model 16. For instance, tools for model compression 19-1 can allow development model 16 to be reduced in size while maintaining a desired level of performance. For instance, model compression 19-1 can include quantization workflows, weight pruning and sparsification techniques, etc. Tools for hardware acceleration 19-2 can facilitate the configuration of the model storage and execution formats to operate optimally on different hardware resources. For instance, hardware acceleration 19-2 can include tools for optimally sharding models for distributed processing over multiple processing units for increased bandwidth, lower unified memory requirements, etc. Tools for distillation 19-3 can provide for the training of lighter-weight models based on the knowledge encoded in development model 16. For instance, development model 16 can be a highly performant, large machine-learned model optimized using model development platform 12. To obtain a lightweight model for running in resource-constrained environments, a smaller model can be a “student model” that learns to imitate development model 16 as a “teacher model.” In this manner, for instance, the investment in learning the parameters and configurations of development model 16 can be efficiently transferred to a smaller model for more efficient inference.

Workbench 15 can implement one, multiple, or none of the toolkits implemented in model development platform 12. Workbench 15 can output an output model 20 based on development model 16. Output model 20 can be a deployment version of development model 16. Output model 20 can be a development or training checkpoint of development model 16. Output model 20 can be a distilled, compressed, or otherwise optimized version of development model 16.

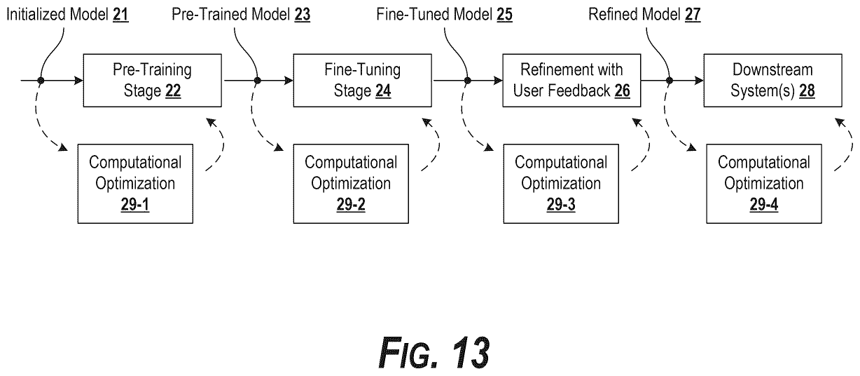

FIG. 13 is a block diagram of an example training flow for training a machine-learned development model 16. One or more portion(s) of the example training flow can be implemented by a computing system that includes one or more computing devices such as, for example, computing systems described with reference to the other figures. Each respective portion of the example training flow can be performed by any (or any combination) of one or more computing devices. Moreover, one or more portion(s) of the example training flow can be implemented on the hardware components of the device(s) described herein, for example, to train one or more systems or models. FIG. 12 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 12 is described with reference to elements/terms described with respect to other systems and figures for exemplary illustrated purposes and is not meant to be limiting. One or more portions of the example training flow can be performed additionally, or alternatively, by other systems.

Initially, development model 16 can persist in an initial state as an initialized model 21. Development model 16 can be initialized with weight values. Initial weight values can be random or based on an initialization schema. Initial weight values can be based on prior pre-training for the same or for a different model.

Initialized model 21 can undergo pre-training in a pre-training stage 22. Pre-training stage 22 can be implemented using one or more pre-training pipelines 17-2 over data from dataset(s) 17-1. Pre-training can be omitted, for example, if initialized model 21 is already pre-trained (e.g., development model 16 contains, is, or is based on a pre-trained foundational model or an expert model).

Pre-trained model 23 can then be a new version of development model 16, which can persist as development model 16 or as a new development model. Pre-trained model 23 can be the initial state if development model 16 was already pre-trained. Pre-trained model 23 can undergo fine-tuning in a fine-tuning stage 24. Fine-tuning stage 24 can be implemented using one or more fine-tuning pipelines 17-3 over data from dataset(s) 17-1. Fine-tuning can be omitted, for example, if a pre-trained model as satisfactory performance, if the model was already fine-tuned, or if other tuning approaches are preferred.

Fine-tuned model 29 can then be a new version of development model 16, which can persist as development model 16 or as a new development model. Fine-tuned model 29 can be the initial state if development model 16 was already fine-tuned. Fine-tuned model 29 can undergo refinement with user feedback 26. For instance, refinement with user feedback 26 can include reinforcement learning, optionally based on human feedback from human users of fine-tuned model 25. As reinforcement learning can be a form of fine-tuning, it is to be understood that fine-tuning stage 24 can subsume the stage for refining with user feedback 26. Refinement with user feedback 26 can produce a refined model 27. Refined model 27 can be output to downstream system(s) 28 for deployment or further development.

In some implementations, computational optimization operations can be applied before, during, or after each stage. For instance, initialized model 21 can undergo computational optimization 29-1 (e.g., using computational optimization toolkit 19) before pre-training stage 22. Pre-trained model 23 can undergo computational optimization 29-2 (e.g., using computational optimization toolkit 19) before fine-tuning stage 24. Fine-tuned model 25 can undergo computational optimization 29-3 (e.g., using computational optimization toolkit 19) before refinement with user feedback 26. Refined model 27 can undergo computational optimization 29-4 (e.g., using computational optimization toolkit 19) before output to downstream system(s) 28. Computational optimization(s) 29-1, . . . , 29-4 can all be the same, all be different, or include at least some different optimization techniques.

### Example Machine-Learned Model Inference System

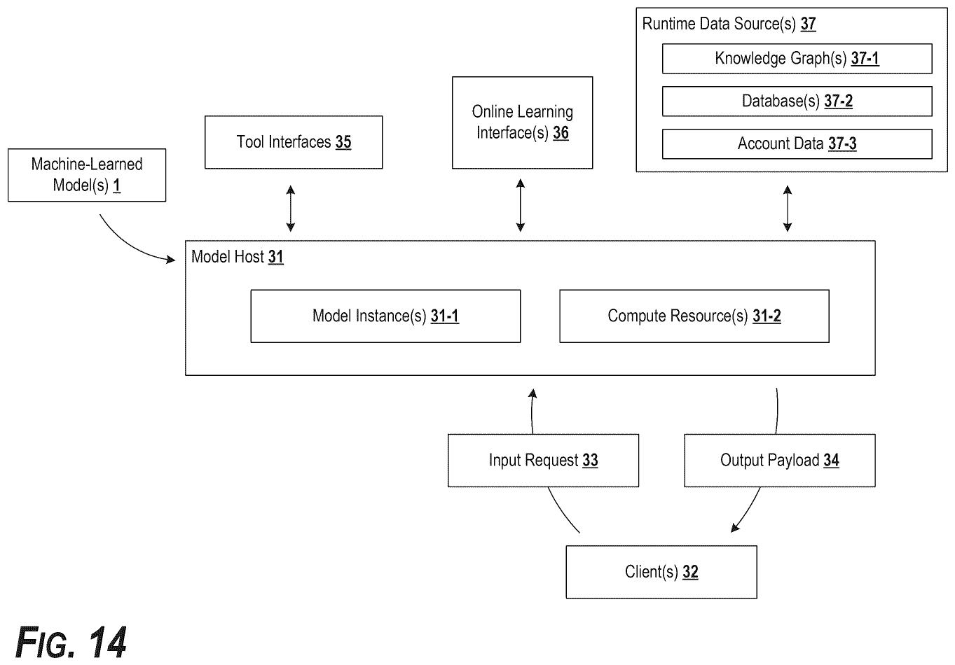

FIG. 14 is a block diagram of an inference system for operating one or more machine-learned model(s) 1 to perform inference (e.g., for training, for deployment, etc.). A model host 31 can receive machine-learned model(s) 1. Model host 31 can host one or more model instance(s) 31-1, which can be one or multiple instances of one or multiple models. Model host 31 can host model instance(s) 31-1 using available compute resources 31-2 associated with model host 31.

Model host 31 can perform inference on behalf of one or more client(s) 32. Client(s) 32 can transmit an input request 33 to model host 31. Using input request 33, model host 31 can obtain input(s) 2 for input to machine-learned model(s) 1. Machine-learned model(s) 1 can process input(s) 2 to generate output(s) 3. Using output(s) 3, model host 31 can return an output payload 34 for responding to input request 33 from client(s) 32. Output payload 34 can include or be based on output(s) 3.

Model host 31 can leverage various other resources and tools to augment the inference task. For instance, model host 31 can communicate with tool interfaces 35 to facilitate tool use by model instance(s) 31-1. Tool interfaces 35 can include local or remote APIs. Tool interfaces 35 can include integrated scripts or other software functionality. Model host 31 can engage online learning interface(s) 36 to facilitate ongoing improvements to machine-learned model(s) 1. For instance, online learning interface(s) 36 can be used within reinforcement learning loops to retrieve user feedback on inferences served by model host 31. Model host 31 can access runtime data source(s) 37 for augmenting input(s) 2 with additional contextual information. For instance, runtime data source(s) 37 can include a knowledge graph 37-1 that facilitates structured information retrieval for information associated with input request(s) 33 (e.g., a search engine service). Runtime data source(s) 37 can include public or private, external or local database(s) 37-2 that can store information associated with input request(s) 33 for augmenting input(s) 2. Runtime data source(s) 37 can include account data 37-3 which can be retrieved in association with a user account corresponding to a client 32 for customizing the behavior of model host 31 accordingly.

Model host 31 can be implemented by one or multiple computing devices or systems. Client(s) 2 can be implemented by one or multiple computing devices or systems, which can include computing devices or systems shared with model host 31.

For example, model host 31 can operate on a server system that provides a machine-learning service to client device(s) that operate client(s) 32 (e.g., over a local or wide-area network). Client device(s) can be end-user devices used by individuals. Client device(s) can be server systems that operate client(s) 32 to provide various functionality as a service to downstream end-user devices.

In some implementations, model host 31 can operate on a same device or system as client(s) 32. Model host 31 can be a machine-learning service that runs on-device to provide machine-learning functionality to one or multiple applications operating on a client device, which can include an application implementing client(s) 32. Model host 31 can be a part of a same application as client(s) 32. For instance, model host 31 can be a subroutine or method implemented by one part of an application, and client(s) 32 can be another subroutine or method that engages model host 31 to perform inference functions within the application. It is to be understood that model host 31 and client(s) 32 can have various different configurations.

Model instance(s) 31-1 can include one or more machine-learned models that are available for performing inference. Model instance(s) 31-1 can include weights or other model components that are stored on in persistent storage, temporarily cached, or loaded into high-speed memory. Model instance(s) 31-1 can include multiple instance(s) of the same model (e.g., for parallel execution of more requests on the same model). Model instance(s) 31-1 can include instance(s) of different model(s). Model instance(s) 31-1 can include cached intermediate states of active or inactive model(s) used to accelerate inference of those models. For instance, an inference session with a particular model may generate significant amounts of computational results that can be re-used for future inference runs (e.g., using a KV cache for transformer-based models). These computational results can be saved in association with that inference session so that session can be executed more efficiently when resumed.

Compute resource(s) 31-2 can include one or more processors (central processing units, graphical processing units, tensor processing units, machine-learning accelerators, etc.) connected to one or more memory devices. Compute resource(s) 31-2 can include a dynamic pool of available resources shared with other processes. Compute resource(s) 31-2 can include memory devices large enough to fit an entire model instance in a single memory instance. Compute resource(s) 31-2 can also shard model instance(s) across multiple memory devices (e.g., using data parallelization or tensor parallelization, etc.). This can be done to increase parallelization or to execute a large model using multiple memory devices which individually might not be able to fit the entire model into memory.

Input request 33 can include data for input(s) 2. Model host 31 can process input request 33 to obtain input(s) 2. Input(s) 2 can be obtained directly from input request 33 or can be retrieved using input request 33. Input request 33 can be submitted to model host 31 via an API.

Model host 31 can perform inference over batches of input requests 33 in parallel. For instance, a model instance 31-1 can be configured with an input structure that has a batch dimension. Separate input(s) 2 can be distributed across the batch dimension (e.g., rows of an array). The separate input(s) 2 can include completely different contexts. The separate input(s) 2 can be multiple inference steps of the same task. The separate input(s) 2 can be staggered in an input structure, such that any given inference cycle can be operating on different portions of the respective input(s) 2. In this manner, for instance, model host 31 can perform inference on the batch in parallel, such that output(s) 3 can also contain the batch dimension and return the inference results for the batched input(s) 2 in parallel. In this manner, for instance, batches of input request(s) 33 can be processed in parallel for higher throughput of output payload(s) 34.

Output payload 34 can include or be based on output(s) 3 from machine-learned model(s) 1. Model host 31 can process output(s) 3 to obtain output payload 34. This can include chaining multiple rounds of inference (e.g., iteratively, recursively, across the same model(s) or different model(s)) to arrive at a final output for a task to be returned in output payload 34. Output payload 34 can be transmitted to client(s) 32 via an API.

Online learning interface(s) 36 can facilitate reinforcement learning of machine-learned model(s) 1. Online learning interface(s) 36 can facilitate reinforcement learning with human feedback (RLHF). Online learning interface(s) 36 can facilitate federated learning of machine-learned model(s) 1.

Model host 31 can execute machine-learned model(s) 1 to perform inference for various tasks using various types of data. For example, various different input(s) 2 and output(s) 3 can be used for various different tasks. In some implementations, input(s) 2 can be or otherwise represent image data. Machine-learned model(s) 1 can process the image data to generate an output. As an example, machine-learned model(s) 1 can process the image data to generate an image recognition output (e.g., a recognition of the image data, a latent embedding of the image data, an encoded representation of the image data, a hash of the image data, etc.). As another example, machine-learned model(s) 1 can process the image data to generate an image segmentation output. As another example, machine-learned model(s) 1 can process the image data to generate an image classification output. As another example, machine-learned model(s) 1 can process the image data to generate an image data modification output (e.g., an alteration of the image data, etc.). As another example, machine-learned model(s) 1 can process the image data to generate an encoded image data output (e.g., an encoded and/or compressed representation of the image data, etc.). As another example, machine-learned model(s) 1 can process the image data to generate an upscaled image data output. As another example, machine-learned model(s) 1 can process the image data to generate a prediction output.

In some implementations, the task is a computer vision task. In some cases, input(s) 2 includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some implementations, input(s) 2 can be or otherwise represent natural language data. Machine-learned model(s) 1 can process the natural language data to generate an output. As an example, machine-learned model(s) 1 can process the natural language data to generate a language encoding output. As another example, machine-learned model(s) 1 can process the natural language data to generate a latent text embedding output. As another example, machine-learned model(s) 1 can process the natural language data to generate a translation output. As another example, machine-learned model(s) 1 can process the natural language data to generate a classification output. As another example, machine-learned model(s) 1 can process the natural language data to generate a textual segmentation output. As another example, machine-learned model(s) 1 can process the natural language data to generate a semantic intent output. As another example, machine-learned model(s) 1 can process the natural language data to generate an upscaled text or natural language output (e.g., text or natural language data that is higher quality than the input text or natural language, etc.). As another example, machine-learned model(s) 1 can process the natural language data to generate a prediction output (e.g., one or more predicted next portions of natural language content).

In some implementations, input(s) 2 can be or otherwise represent speech data (e.g., data describing spoken natural language, such as audio data, textual data, etc.). Machine-learned model(s) 1 can process the speech data to generate an output. As an example, machine-learned model(s) 1 can process the speech data to generate a speech recognition output. As another example, machine-learned model(s) 1 can process the speech data to generate a speech translation output. As another example, machine-learned model(s) 1 can process the speech data to generate a latent embedding output. As another example, machine-learned model(s) 1 can process the speech data to generate an encoded speech output (e.g., an encoded and/or compressed representation of the speech data, etc.). As another example, machine-learned model(s) 1 can process the speech data to generate an upscaled speech output (e.g., speech data that is higher quality than the input speech data, etc.). As another example, machine-learned model(s) 1 can process the speech data to generate a textual representation output (e.g., a textual representation of the input speech data, etc.). As another example, machine-learned model(s) 1 can process the speech data to generate a prediction output.

In some implementations, input(s) 2 can be or otherwise represent latent encoding data (e.g., a latent space representation of an input, etc.). Machine-learned model(s) 1 can process the latent encoding data to generate an output. As an example, machine-learned model(s) 1 can process the latent encoding data to generate a recognition output. As another example, machine-learned model(s) 1 can process the latent encoding data to generate a reconstruction output. As another example, machine-learned model(s) 1 can process the latent encoding data to generate a search output. As another example, machine-learned model(s) 1 can process the latent encoding data to generate a reclustering output. As another example, machine-learned model(s) 1 can process the latent encoding data to generate a prediction output.

In some implementations, input(s) 2 can be or otherwise represent statistical data. Statistical data can be, represent, or otherwise include data computed and/or calculated from some other data source. Machine-learned model(s) 1 can process the statistical data to generate an output. As an example, machine-learned model(s) 1 can process the statistical data to generate a recognition output. As another example, machine-learned model(s) 1 can process the statistical data to generate a prediction output. As another example, machine-learned model(s) 1 can process the statistical data to generate a classification output. As another example, machine-learned model(s) 1 can process the statistical data to generate a segmentation output. As another example, machine-learned model(s) 1 can process the statistical data to generate a visualization output. As another example, machine-learned model(s) 1 can process the statistical data to generate a diagnostic output.

In some implementations, input(s) 2 can be or otherwise represent sensor data. Machine-learned model(s) 1 can process the sensor data to generate an output. As an example, machine-learned model(s) 1 can process the sensor data to generate a recognition output. As another example, machine-learned model(s) 1 can process the sensor data to generate a prediction output. As another example, machine-learned model(s) 1 can process the sensor data to generate a classification output. As another example, machine-learned model(s) 1 can process the sensor data to generate a segmentation output. As another example, machine-learned model(s) 1 can process the sensor data to generate a visualization output. As another example, machine-learned model(s) 1 can process the sensor data to generate a diagnostic output. As another example, machine-learned model(s) 1 can process the sensor data to generate a detection output.

In some implementations, machine-learned model(s) 1 can be configured to perform a task that includes encoding input data for reliable and/or efficient transmission or storage (and/or corresponding decoding). For example, the task may be an audio compression task. The input may include audio data and the output may comprise compressed audio data. In another example, the input includes visual data (e.g. one or more images or videos), the output comprises compressed visual data, and the task is a visual data compression task. In another example, the task may comprise generating an embedding for input data (e.g. input audio or visual data). In some cases, the input includes audio data representing a spoken utterance and the task is a speech recognition task. The output may comprise a text output which is mapped to the spoken utterance. In some cases, the task comprises encrypting or decrypting input data. In some cases, the task comprises a microprocessor performance task, such as branch prediction or memory address translation.

In some implementations, the task is a generative task, and machine-learned model(s) 1 can be configured to output content generated in view of input(s) 2. For instance, input(s) 2 can be or otherwise represent data of one or more modalities that encodes context for generating additional content.

In some implementations, the task can be a text completion task. Machine-learned model(s) 1 can be configured to process input(s) 2 that represent textual data and to generate output(s) 3 that represent additional textual data that completes a textual sequence that includes input(s) 2. For instance, machine-learned model(s) 1 can be configured to generate output(s) 3 to complete a sentence, paragraph, or portion of text that follows from a portion of text represented by input(s) 2.

In some implementations, the task can be an instruction following task. Machine-learned model(s) 1 can be configured to process input(s) 2 that represent instructions to perform a function and to generate output(s) 3 that advance a goal of satisfying the instruction function (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the instructions (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the instructions (e.g., natural language responses, programming language responses, machine language responses, etc.). One or more output(s) 3 can be iteratively or recursively generated to sequentially process and accomplish steps toward accomplishing the requested functionality. For instance, an initial output can be executed by an external system or be processed by machine-learned model(s) 1 to complete an initial step of performing a function. Multiple steps can be performed, with a final output being obtained that is responsive to the initial instructions.

In some implementations, the task can be a question answering task. Machine-learned model(s) 1 can be configured to process input(s) 2 that represent a question to answer and to generate output(s) 3 that advance a goal of returning an answer to the question (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the question (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the question (e.g., natural language responses, programming language responses, machine language responses, etc.). One or more output(s) 3 can be iteratively or recursively generated to sequentially process and accomplish steps toward answering the question. For instance, an initial output can be executed by an external system or be processed by machine-learned model(s) 1 to complete an initial step of obtaining an answer to the question (e.g., querying a database, performing a computation, executing a script, etc.). Multiple steps can be performed, with a final output being obtained that is responsive to the question.

In some implementations, the task can be an image generation task. Machine-learned model(s) 1 can be configured to process input(s) 2 that represent context regarding a desired portion of image content. The context can include text data, image data, audio data, etc. Machine-learned model(s) 1 can be configured to generate output(s) 3 that represent image data that depicts imagery related to the context. For instance, machine-learned model(s) 1 can be configured to generate pixel data of an image. Values for channel(s) associated with the pixels in the pixel data can be selected based on the context (e.g., based on a probability determined based on the context).

In some implementations, the task can be an audio generation task. Machine-learned model(s) 1 can be configured to process input(s) 2 that represent context regarding a desired portion of audio content. The context can include text data, image data, audio data, etc. Machine-learned model(s) 1 can be configured to generate output(s) 3 that represent audio data related to the context. For instance, machine-learned model(s) 1 can be configured to generate waveform data in the form of an image (e.g., a spectrogram). Values for channel(s) associated with pixels of the image can be selected based on the context. Machine-learned model(s) 1 can be configured to generate waveform data in the form of a sequence of discrete samples of a continuous waveform. Values of the sequence can be selected based on the context (e.g., based on a probability determined based on the context).

In some implementations, the task can be a data generation task. Machine-learned model(s) 1 can be configured to process input(s) 2 that represent context regarding a desired portion of data (e.g., data from various data domains, such as sensor data, image data, multimodal data, statistical data, etc.). The desired data can be, for instance, synthetic data for training other machine-learned models. The context can include arbitrary data type(s). Machine-learned model(s) 1 can be configured to generate output(s) 3 that represent data that aligns with the desired data. For instance, machine-learned model(s) 1 can be configured to generate data values for populating a dataset. Values for the data object(s) can be selected based on the context (e.g., based on a probability determined based on the context).

### Example Computing Systems and Devices

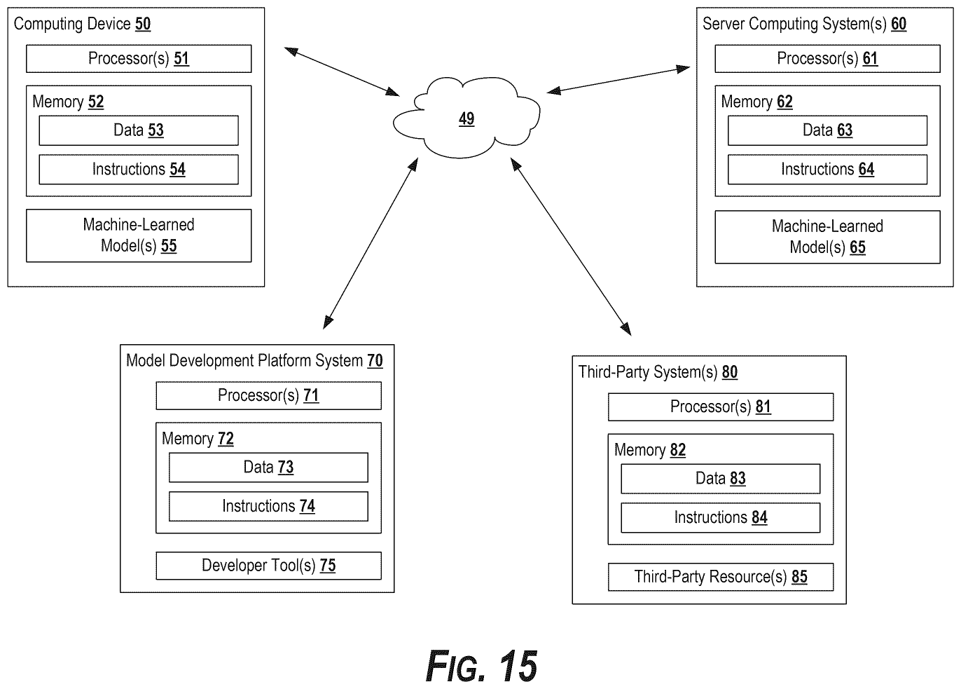

FIG. 15 is a block diagram of an example networked computing system that can perform aspects of example implementations of the present disclosure. The system can include a number of computing devices and systems that are communicatively coupled over a network 49. An example computing device 50 is described to provide an example of a computing device that can perform any aspect of the present disclosure (e.g., implementing model host 31, client(s) 32, or both). An example server computing system 60 is described as an example of a server computing system that can perform any aspect of the present disclosure (e.g., implementing model host 31, client(s) 32, or both). Computing device 50 and server computing system(s) 60 can cooperatively interact (e.g., over network 49) to perform any aspect of the present disclosure (e.g., implementing model host 31, client(s) 32, or both). Model development platform system 70 is an example system that can host or serve model development platform(s) 12 for development of machine-learned models. Third-party system(s) 80 are example system(s) with which any of computing device 50, server computing system(s) 60, or model development platform system(s) 70 can interact in the performance of various aspects of the present disclosure (e.g., engaging third-party tools, accessing third-party databases or other resources, etc.).

Network 49 can be any type of communications network, such as a local area network (e.g., intranet), wide area network (e.g., Internet), or some combination thereof and can include any number of wired or wireless links. In general, communication over network 49 can be carried via any type of wired or wireless connection, using a wide variety of communication protocols (e.g., TCP/IP, HTTP, SMTP, FTP), encodings or formats (e.g., HTML, XML), or protection schemes (e.g., VPN, secure HTTP, SSL). Network 49 can also be implemented via a system bus. For instance, one or more devices or systems of FIG. 15 can be co-located with, contained by, or otherwise integrated into one or more other devices or systems.

Computing device 50 can be any type of computing device, such as, for example, a personal computing device (e.g., laptop or desktop), a mobile computing device (e.g., smartphone or tablet), a gaming console or controller, a wearable computing device, an embedded computing device, a server computing device, a virtual machine operating on a host device, or any other type of computing device. Computing device 50 can be a client computing device. Computing device 50 can be an end-user computing device. Computing device 50 can be a computing device of a service provided that provides a service to an end user (who may use another computing device to interact with computing device 50).

Computing device 50 can include one or more processors 51 and a memory 52. Processor(s) 51 can be any suitable processing device (e.g., a processor core, a microprocessor, an ASIC, an FPGA, a controller, a microcontroller, etc.) and can be one processor or a plurality of processors that are operatively connected. Memory 52 can include one or more non-transitory computer-readable storage media, such as HBM, RAM, ROM, EEPROM, EPROM, flash memory devices, magnetic disks, etc., and combinations thereof. Memory 52 can store data 53 and instructions 54 which can be executed by processor(s) 51 to cause computing device 50 to perform operations. The operations can implement any one or multiple features described herein. The operations can implement example methods and techniques described herein.

Computing device 50 can also include one or more input components that receive user input. For example, a user input component can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, camera, LIDAR, a physical keyboard or other buttons, or other means by which a user can provide user input.

Computing device 50 can store or include one or more machine-learned models 55. Machine-learned models 55 can include one or more machine-learned model(s) 1, such as a sequence processing model 4. Machine-learned models 55 can include one or multiple model instance(s) 31-1. Machine-learned model(s) 55 can be received from server computing system(s) 60, model development platform system 70, third party system(s) 80 (e.g., an application distribution platform), or developed locally on computing device 50. Machine-learned model(s) 55 can be loaded into memory 52 and used or otherwise implemented by processor(s) 51. Computing device 50 can implement multiple parallel instances of machine-learned model(s) 55.

Server computing system(s) 60 can include one or more processors 61 and a memory 62. Processor(s) 61 can be any suitable processing device (e.g., a processor core, a microprocessor, an ASIC, an FPGA, a controller, a microcontroller, etc.) and can be one processor or a plurality of processors that are operatively connected. Memory 62 can include one or more non-transitory computer-readable storage media, such as HBM, RAM, ROM, EEPROM, EPROM, flash memory devices, magnetic disks, etc., and combinations thereof. Memory 62 can store data 63 and instructions 64 which can be executed by processor(s) 61 to cause server computing system(s) 60 to perform operations. The operations can implement any one or multiple features described herein. The operations can implement example methods and techniques described herein.

In some implementations, server computing system 60 includes or is otherwise implemented by one or multiple server computing devices. In instances in which server computing system 60 includes multiple server computing devices, such server computing devices can operate according to sequential computing architectures, parallel computing architectures, or some combination thereof.

Server computing system 60 can store or otherwise include one or more machine-learned models 65. Machine-learned model(s) 65 can be the same as or different from machine-learned model(s) 55. Machine-learned models 65 can include one or more machine-learned model(s) 1, such as a sequence processing model 4. Machine-learned models 65 can include one or multiple model instance(s) 31-1. Machine-learned model(s) 65 can be received from computing device 50, model development platform system 70, third party system(s) 80, or developed locally on server computing system(s) 60. Machine-learned model(s) 65 can be loaded into memory 62 and used or otherwise implemented by processor(s) 61. Server computing system(s) 60 can implement multiple parallel instances of machine-learned model(s) 65.

In an example configuration, machine-learned models 65 can be included in or otherwise stored and implemented by server computing system 60 to establish a client-server relationship with computing device 50 for serving model inferences. For instance, server computing system(s) 60 can implement model host 31 on behalf of client(s) 32 on computing device 50. For instance, machine-learned models 65 can be implemented by server computing system 60 as a portion of a web service (e.g., remote machine-learned model hosting service, such as an online interface for performing machine-learned model operations over a network on server computing system(s) 60). For instance, server computing system(s) 60 can communicate with computing device 50 over a local intranet or internet connection. For instance, computing device 50 can be a workstation or endpoint in communication with server computing system(s) 60, with implementation of machine-learned models 65 being managed by server computing system(s) 60 to remotely perform inference (e.g., for runtime or training operations), with output(s) returned (e.g., cast, streamed, etc.) to computing device 50. Machine-learned models 65 can work cooperatively or interoperatively with machine-learned models 55 on computing device 50 to perform various tasks.

Model development platform system(s) 70 can include one or more processors 71 and a memory 72. Processor(s) 71 can be any suitable processing device (e.g., a processor core, a microprocessor, an ASIC, an FPGA, a controller, a microcontroller, etc.) and can be one processor or a plurality of processors that are operatively connected. Memory 72 can include one or more non-transitory computer-readable storage media, such as HBM, RAM, ROM, EEPROM, EPROM, flash memory devices, magnetic disks, etc., and combinations thereof. Memory 72 can store data 73 and instructions 74 which can be executed by processor(s) 71 to cause model development platform system(s) 70 to perform operations. The operations can implement any one or multiple features described herein. The operations can implement example methods and techniques described herein. Example operations include the functionality described herein with respect to model development platform 12. This and other functionality can be implemented by developer tool(s) 75.

Third-party system(s) 80 can include one or more processors 81 and a memory 82. Processor(s) 81 can be any suitable processing device (e.g., a processor core, a microprocessor, an ASIC, an FPGA, a controller, a microcontroller, etc.) and can be one processor or a plurality of processors that are operatively connected. Memory 82 can include one or more non-transitory computer-readable storage media, such as HBM, RAM, ROM, EEPROM, EPROM, flash memory devices, magnetic disks, etc., and combinations thereof. Memory 82 can store data 83 and instructions 84 which can be executed by processor(s) 81 to cause third-party system(s) 80 to perform operations. The operations can implement any one or multiple features described herein. The operations can implement example methods and techniques described herein. Example operations include the functionality described herein with respect to tools and other external resources called when training or performing inference with machine-learned model(s) 1, 4, 16, 20, 55, 65, etc. (e.g., third-party resource(s) 85).

FIG. 15 illustrates one example arrangement of computing systems that can be used to implement the present disclosure. Other computing system configurations can be used as well. For example, in some implementations, one or both of computing system 50 or server computing system(s) 60 can implement all or a portion of the operations of model development platform system 70. For example, computing system 50 or server computing system(s) 60 can implement developer tool(s) 75 (or extensions thereof) to develop, update/train, or refine machine-learned models 1, 4, 16, 20, 55, 65, etc. using one or more techniques described herein with respect to model alignment toolkit 17. In this manner, for instance, computing system 50 or server computing system(s) 60 can develop, update/train, or refine machine-learned models based on local datasets (e.g., for model personalization/customization, as permitted by user data preference selections).

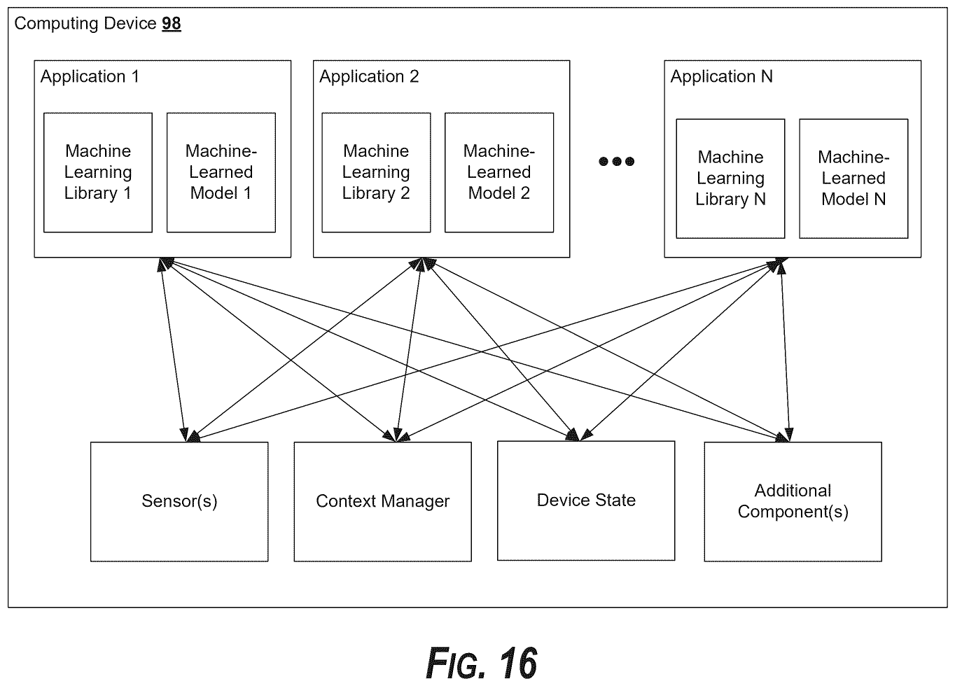

FIG. 16 is a block diagram of an example computing device 98 that performs according to example embodiments of the present disclosure. Computing device 98 can be a user computing device or a server computing device (e.g., computing device 50, server computing system(s) 60, etc.). Computing device 98 can implement model host 31. For instance, computing device 98 can include a number of applications (e.g., applications 1 through N). Each application can contain its own machine learning library and machine-learned model(s). For example, each application can include a machine-learned model. Example applications include a text messaging application, an email application, a dictation application, a virtual keyboard application, a browser application, etc. As illustrated in FIG. 16, each application can communicate with a number of other components of the computing device, such as, for example, one or more sensors, a context manager, a device state component, or additional components. In some implementations, each application can communicate with each device component using an API (e.g., a public API). In some implementations, the API used by each application is specific to that application.

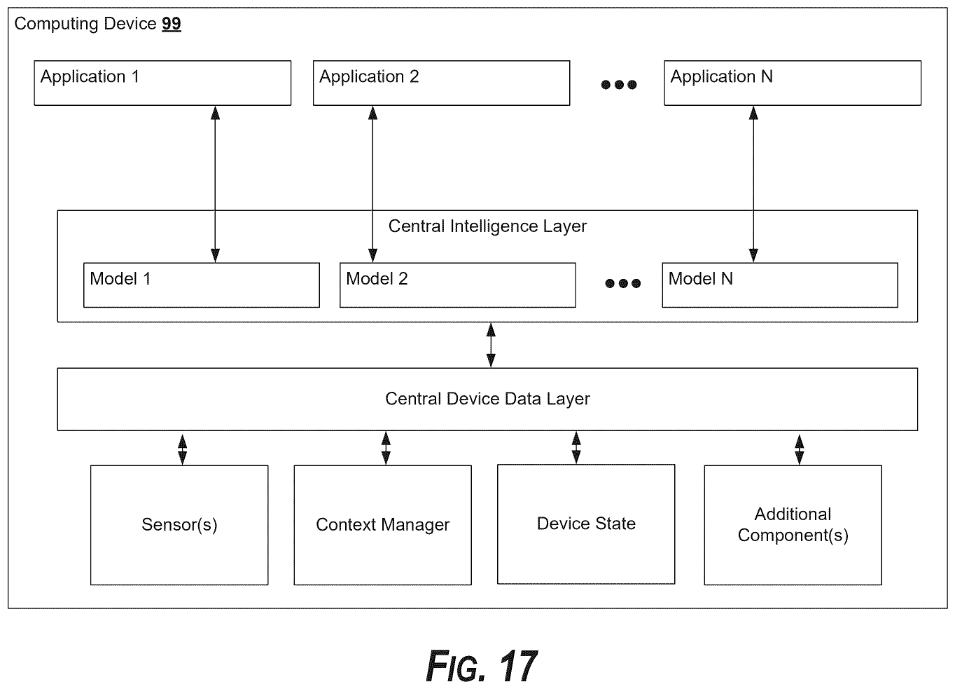

FIG. 17 is a block diagram of an example computing device 99 that performs according to example embodiments of the present disclosure. Computing device 99 can be the same as or different from computing device 98. Computing device 99 can be a user computing device or a server computing device (e.g., computing device 50, server computing system(s) 60, etc.). Computing device 98 can implement model host 31. For instance, computing device 99 can include a number of applications (e.g., applications 1 through N). Each application can be in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer can include a number of machine-learned models. For example, as illustrated in FIG. 17, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of computing device 99.

The central intelligence layer can communicate with a central device data layer. The central device data layer can be a centralized repository of data for computing device 99. As illustrated in FIG. 17, the central device data layer can communicate with a number of other components of the computing device, such as, for example, one or more sensors, a context manager, a device state component, or additional components. In some implementations, the central device data layer can communicate with each device component using an API (e.g., a private API).

### Additional Disclosure

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

Aspects of the disclosure have been described in terms of illustrative embodiments thereof. Any and all features in the following claims can be combined or rearranged in any way possible, including combinations of claims not explicitly enumerated in combination together, as the example claim dependencies listed herein should not be read as limiting the scope of possible combinations of features disclosed herein. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. Clauses and other sequences of items joined by a particular conjunction such as “or,” for example, can refer to “and/or,” “at least one of”, “any combination of” example elements listed therein, etc. Terms such as “based on” should be understood as “based at least in part on.”

The term “can” should be understood as referring to a possibility of a feature in various implementations and not as prescribing an ability that is necessarily present in every implementation. For example, the phrase “X can perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

The term “may” should be understood as referring to a possibility of a feature in various implementations and not as prescribing an ability that is necessarily present in every implementation. For example, the phrase “X may perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

What is claimed is:

1. A computing system for reward or preference optimization of sequence processing models, the computing system comprising:
one or more processors; and
one or more non-transitory computer-readable media that collectively store instructions that, when executed by the one or more processors, cause the computing system to perform operations, the operations comprising:
obtaining, by the computing system, a training example comprising one or more sequences of tokens and one or more reward or preference labels respectively associated with the one or more sequences of tokens;
evaluating, by the computing system, an optimization function based on: (i) a reference score generated by a reference sequence processing model for the one or more sequences of tokens and (ii) a target score generated by a target sequence processing model for the one or more sequences of tokens;
wherein the optimization function comprises a reward or preference function that is fit to the one or more reward or preference labels using a training loss function;
wherein the reward or preference function provides a predicted reward or preference score expressed in terms of both the reference score and the target score; and
wherein the training loss function comprises a matching loss function that evaluates an area under a monotonically-non-decreasing link function from a label value of the one or more reward or preference labels to the predicted reward or preference score; and
modifying, by the computing system, one or more values of one or more parameters of the target sequence processing model based on the optimization loss function.

2. The computing system of claim 1, wherein:
the one or more sequences of tokens comprise a single-trajectory sequence of tokens;
the one or more reward or preference labels comprise a pointwise reward label for the single sequence of tokens;
the reward or preference score comprises a reward score expressed in terms of the reference score and the target score; and
the matching loss function is applied to fit the pointwise reward label of the single-trajectory sequence of tokens to the reward score.

3. The computing system of claim 1, wherein:
the one or more sequences of tokens comprises a pair of sequences of tokens;
the one or more reward or preference labels comprise a preference label for the pair of sequences of tokens;
the reward or preference score comprises a preference score expressed in terms of the reference scores and the target scores for the pair of sequences of tokens; and
the matching loss function is applied to fit the preference label of the pair of sequences of tokens to the preference score.

4. The computing system of claim 1, wherein the link function comprises an asymmetric function.

5. The computing system of claim 1, wherein the link function comprises an exponential function.

6. The computing system of claim 1, wherein the link function comprises a linear function, a standard Sigmoid function, or a Sigmoid function that has been one or both of scaled and shifted.

7. The computing system of claim 3, wherein the link function comprises a hyperbolic sine function, a hyperbolic arctangent function, an arcsin function, or an asymmetric function convex on a first quadrant that has been scaled.

8. The computing system of claim 1, wherein the optimization function is analytically inexpressible but a gradient of the training loss function comprises a difference in evaluations of the link function at the predicted reward or preference score and the label value, and wherein evaluating, by the computing system, the optimization function comprises determining, by the computing system, a gradient of the optimization function.

9. The computing system of claim 1, wherein the predicted reward or preference score and the label value comprise logit scores.

10. The computing system of claim 1, wherein the predicted reward or preference score and the label value comprise probabilities.

11. The computing system of claim 1, wherein the one or more reward or preference labels comprise fractional labels that designate a fractional level of reward or preference.

12. The computing system of claim 2, wherein the optimization function is directly defined with the link function through its gradient relative to the target score but not the reward function.

13. The computing system of claim 1, wherein the optimization function further comprises or is derived from a regularization term that penalizes a divergence between the reference score and the target score.

14. The computing system of claim 13, wherein the regularization term comprises a second matching loss function that evaluates a second area under a second monotonically-non-decreasing link function from the target score to the reference score.

15. A computer-implemented method for reward or preference optimization of sequence processing models, the method comprising:
obtaining, by a computing system comprising one or more computing devices, a reward or preference training example comprising one or more sequences of tokens and one or more reward or preference labels respectively associated with the one or more sequences of tokens;
evaluating, by the computing system, an optimization function based on: (i) a reference score generated by a reference sequence processing model for the one or more sequences of tokens and (ii) a target score generated by a target sequence processing model for the one or more sequences of tokens;
wherein the optimization function comprises or is derived from a regularization term that penalizes divergence between the reference score and the target score; and
wherein the regularization term comprises a matching loss function that evaluates an area under a monotonically-non-decreasing link function from the reference score to the target score; and
modifying, by the computing system, one or more values of one or more parameters of the target sequence processing model based on the optimization loss function.

16. The computer-implemented method of claim 15, wherein the link function comprises an asymmetric function

17. The computer-implemented method of claim 15, wherein the link function comprises an exponential function.

18. The computer-implemented method of claim 15, wherein the link function comprises a linear function, a standard Sigmoid function, or a Sigmoid function that has been one or both of scaled and shifted.

19. The computer-implemented method of claim 15, wherein the link function comprises a hyperbolic sine function, a hyperbolic arctangent function, an arcsin function, or an asymmetric function convex on the first quadrant that has been scaled.

20. The computer-implemented method of claim 15, wherein the link function is applied directly to a sequence pairwise difference of the target and reference scores.

21. A computer-implemented method for performing reward or preference optimization, the method comprising:
obtaining, by a computing system comprising one or more computing devices, a plurality of training examples each comprising one or more sequences of tokens and one or more reward or preference labels respectively associated with the one or more sequences of tokens;
training, by the computing system, a reward or preference model on the plurality of training examples, wherein training the reward or preference model comprises training the reward or preference model to generate a reward or preference score for a given sequence,
wherein, for at least one of the training examples, training the reward or preference model comprises evaluating a matching loss function that evaluates an area under a monotonically-non-decreasing link function from a label value of the one or more reward or preference labels included in the training example to the reward or preference score generated by the reward or preference model; and
performing, by the computing system, optimization of a target sequence processing model with respect to the reward or preference model, wherein the optimization is performed using training example sequences generated by the target sequence processing model,
wherein, for at least one of the training example sequences generated by the target sequence processing model, performing optimization of the target sequence processing model comprises evaluating a gradient of a matching loss function that evaluates the derivative of an area under a monotonically-non-decreasing link function from a reward or preference label or an expected label value of another sequence or sequences to the reward or preference score generated by the reward or preference model.

22. A computer-implemented method for performing reward or preference optimization, the method comprising:
obtaining, by a computing system comprising one or more computing devices, a plurality of training examples each comprising one or more sequences of tokens and one or more reward or preference labels respectively associated with the one or more sequences of tokens;
training, by the computing system, a reward or preference model on the plurality of training examples, wherein training the reward or preference model comprises training the reward or preference model to generate a reward or preference score for a given sequence; and
performing, by the computing system, optimization of a target sequence processing model with respect to the reward or preference model, wherein the optimization is performed using training example sequences generated by the target sequence processing model;
wherein performing the optimization of the target sequence processing model comprises evaluating a regularization term that comprises a matching loss function that evaluates an area under a monotonically-non-decreasing link function from a reference score generated by a reference sequence processing model to the target score generated by the target sequence processing model.
